(19) United States
(12) Patent Application Publication
(10) Pub. No.: US 2016/0171518 A1
(43) Pub. Date: Jun. 16, 2016

(54) SPONSOR ACCESS TO INCENTIVIZED CUSTOMER ACCOUNT GOALS

(71) Applicant: EMPIRE TECHNOLOGY DEVELOPMENT LLC, WILMINGTON, DE (US)

(72) Inventor: SHMUEL UR, SHORASHIM (IL)

(21) Appl. No.: 14/434,062

(22) PCT Filed: Dec. 12, 2014
(86) PCT No.: PCT/US14/69911

§ 371 Date: Apr. 7, 2015

(51) Int. Cl. G06Q 30/02; G06Q 40/02

(52) U.S. Cl. CPC G06Q 30/0215; G06Q 40/02

(57) ABSTRACT

Technologies related to sponsor access to incentivized customer account goals are generally described. In some examples, a customer account may include incentivized customer account goals, also referred to herein as “incentivized goals”. Each incentivized goal may include a customer reserve amount controlled by a customer and a sponsor incentive amount. The sponsor incentive amount may be adjusted based on the customer reserve amount according to a sponsor incentive formula or rule. Sponsors may be given limited sponsor level access to financial account information pertaining to their sponsored incentivized goals. A clearinghouse may connect or associate multiple sponsors with multiple customers, including customers with customer accounts at multiple financial institutions.

### BACKGROUND

Unless otherwise indicated herein, the materials described in this section are not prior art to the claims in this application and are not admitted to be prior art by inclusion in this section.

Traditional bank accounts may be accessed electronically via bank websites, allowing customers to access account balances and transaction histories. In addition to basic account access, a variety of technologies may provide extended account visualization and management features. For example, some banks may provide tools to categorize spending, allowing customers to visualize their categorized spending and make adjustments. Some banks may provide tools to compartmentalize account funds according to intended purposes, such as money saved for a vacation, a car, or an electronic device purchase.

Providing extended account visualization and management technologies may improve customer retention as well as attract new customers. Such technologies may also lead to positive life changes for customers, who may be discouraged from impulsive spending patterns and motivated to manage their accounts in a deliberate manner. Therefore, there is an ongoing need for new and improved account visualization and management technologies.

### SUMMARY

The present disclosure generally describes technologies including devices, methods, and computer readable media relating to sponsor access to incentivized customer account goals, also referred to herein as “incentivized goals”. Some example methods may comprise providing, by a server computing device, based on customer security credentials, customer level access to stored financial account information from a customer account, wherein the customer level access to the stored financial account information includes multiple respective incentivized goals. Each respective incentivized goal may include, for example, a goal description, a goal amount, a customer reserve amount, and a sponsor incentive amount. The customer reserve amount may include a portion of the customer account reserved for the respective incentivized goal, and the customer reserve amount may be controllable by transfers between the customer reserve amount and other portions of the customer account. The sponsor incentive amount may include an amount committed by a sponsor to the respective incentivized goal, wherein the sponsor incentive amount may be restricted to the respective incentivized goal and may be non-transferrable to other portions of the customer account. Example methods may comprise varying, by the server computing device, sponsor incentive amounts for each respective incentivized goal according to sponsor incentive formulas for each respective incentivized goal, wherein the sponsor incentive formulas may progressively adjust sponsor incentive amounts based on customer reserve amounts. Example methods may also comprise providing, by the server computing device, based on sponsor security credentials, sponsor level access to the stored financial account information, wherein the sponsor level access to the stored financial account information may include a subset of the multiple respective incentivized goals included in the customer level access to the stored financial account information. The subset may include incentivized goals associated with the sponsor security credentials and may exclude incentivized goals not associated with the sponsor security credentials.

Some example methods may comprise clearinghouse methods to enable multiple sponsor access to incentivized goals for multiple customer accounts. Example clearinghouse methods may include receiving, by a clearinghouse server, multiple incentivized goal offers from multiple sponsors and providing, by the clearinghouse server, the multiple incentivized goal offers to multiple customers, wherein the multiple customers may include customers with customer accounts at multiple financial institutions. Each of the multiple incentivized goal offers may include, e.g., a goal description, a goal amount, and/or a sponsor incentive formula to progressively adjust a sponsor incentive amount includable in a customer account, based on a customer reserve amount includable in the customer account. Example clearinghouse methods may include receiving, by the clearinghouse server, multiple incentivized goal offer selections from the multiple customers and providing, by the clearinghouse server, the multiple incentivized goal offer selections to the multiple sponsors; receiving, by the clearinghouse server, multiple customer reserve amounts for multiple incentivized goals established in the customer accounts at the multiple financial institutions pursuant to the multiple incentivized goal offer selections, and providing, by the clearinghouse server, the multiple customer reserve amounts to the multiple sponsors; and receiving, by the clearinghouse server, multiple sponsor incentive amounts for the multiple incentivized goals established in the customer accounts and providing, by the clearinghouse server, the multiple sponsor incentive amounts to the multiple customers.

Computing devices and computer readable media having instructions implementing the various technologies described herein are also disclosed. Example computer readable media may comprise non-transitory computer readable storage media having computer executable instructions executable by a processor, the instructions that, when executed by the processor, cause the processor to carry out any combination of the various methods provided herein. Example computing devices may include servers comprising a processor, a memory, and an incentivized goal manager and/or a clearinghouse mediator configured to carry out the methods described herein.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 is a diagram illustrating an example customer account including incentivized goals;

FIG. 2 is a block diagram illustrating an example server computing device;

FIG. 3 is a block diagram illustrating an example clearinghouse server;

FIG. 4 is a block diagram of a computing device as one example of a server computing device and clearinghouse server;

FIG. 5 is a flow diagram illustrating an example method configured to enable sponsor access to incentivized goals;

FIG. 6 is a flow diagram illustrating an example clearinghouse method configured to enable multiple sponsor access to incentivized goals for multiple customer accounts; and

FIG. 7 is a schematic diagram illustrating an example distributed arrangement and an example clearinghouse arrangement, all arranged in accordance with at least some embodiments of the present disclosure.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, may be arranged, substituted, combined, and designed in a wide variety of different configurations, all of which are explicitly contemplated and made part of this disclosure.

The present disclosure is generally drawn, inter alia, to technologies including methods, devices, systems and/or computer readable media deployed therein relating to sponsor access to incentivized customer account goals. In some examples, a customer account may include incentivized customer account goals, also referred to herein as “incentivized goals”. Each incentivized goal may include a customer reserve amount controlled by a customer, and a sponsor incentive amount. The sponsor incentive amount may be adjusted based on the customer reserve amount according to a sponsor incentive formula or rule. Sponsors may be given limited sponsor level access to financial account information pertaining to their sponsored incentivized goals. A clearinghouse may connect or associate multiple sponsors with multiple customers, including customers with customer accounts at multiple financial institutions.

For example, in some embodiments, incentivized goals may include purchase goals, to thereby incentivize customers to save towards purchases of products or services. Incentivized goals may be visually represented as incentivized goal objects in customer accounts. Each incentivized goal object may include, e.g., a goal description such as a description of a purchasable product or service; a goal amount such as a cost of the purchasable product or service; a customer reserve amount representing an amount saved by the customer towards the purchasable product or service; and a sponsor incentive amount representing an amount committed by a sponsor, such as a merchant of the purchasable product or service, to the purchase of the purchasable product or service from the merchant. Merchants may sponsor purchase goals for example by discounting purchasable products or services at sponsor incentive amounts when the purchasable products or services are purchased.

For example, a customer may establish an incentivized goal to purchase a vehicle. The customer may select, e.g., from a webpage comprising incentivized goal offers, an incentivized goal offer available from a car dealership. Selecting the car dealership's incentivized goal offer may activate a server computing device to establish a vehicle purchase incentivized goal in the customer's account at a financial institution such as a bank. The server computing device may establish the incentivized goal in the customer's account by placing an incentivized goal object in the customer's account. The incentivized goal object may include a description of the vehicle, cost of the vehicle, a car dealership sponsoring the incentivized goal, any initial customer reserve amount reserved for the vehicle purchase, and/or any initial sponsor incentive amount comprising a discount applicable by the car dealership when the vehicle is purchased. The incentivized goal may be included in the customer's view of their customer account, e.g., in customer account webpages accessed by logging into the customer account via the Internet. Subsequent to establishing the incentivized goal in the customer's account, the server computing device may, e.g., execute a sponsor incentive formula associated with the incentivized goal each time the customer increases or otherwise adjusts the customer reserve amount. Executing the sponsor incentive formula may produce an adjusted sponsor incentive amount. The server computing device may include the updated customer reserve amount and adjusted sponsor incentive amount in the incentivized goal object in the customer's account.

In some embodiments, methods according to this disclosure may be performed by an appropriately configured server computing device, such as a financial institution server or a clearinghouse server. A financial institution server may be configured to support electronic access to customer accounts maintained by a bank or other financial institution. A clearinghouse server may be configured to communicate with financial institution servers to provide a clearinghouse, as described in connection with various embodiments of this disclosure.

The server computing device may be configured to provide, e.g., to a customer having a customer account, customer level access to stored financial account information from the customer account. The server computing device may be configured to provide, e.g., to sponsors that sponsor incentivized goals, limited sponsor level access to the stored financial account information from the customer account. The server computing device may provide customer level access to the stored financial account information based on customer security credentials, e.g., based on a customer username and a customer password, a customer digital certificate, or other customer security credentials. The server computing device may provide sponsor level access to the stored financial account information based on sponsor security credentials, e.g., based on a sponsor username and a sponsor password, a sponsor digital certificate, or other sponsor security credentials.

The customer level access may include, e.g., full account access including multiple respective incentivized goals established by the customer for the customer account. The limited sponsor level access may include, e.g., a subset of the multiple respective incentivized goals established by the customer for the customer account. The subset may include those incentivized goals which are sponsored by the sponsor, and which may therefore be associated with the sponsor security credentials, e.g., in a database. The subset may exclude those incentivized goals which are not sponsored by the sponsor, which incentivized goals may therefore not be associated with the sponsor security credentials.

In some embodiments, the multiple respective incentivized goals established by the customer for the customer account may include incentivized goals which are sponsored by multiple different sponsors. The server computing device may be configured to provide differently configured sponsor level access to each of the multiple different sponsors. The sponsor level access provided to each of the multiple different sponsors may include different subsets of the multiple respective incentivized goals established by the customer for the customer account, based on the sponsor(s) associated with each of the multiple respective incentivized goals.

Each respective incentivized goal may include, for example, a goal description, a goal amount, a customer reserve amount, and/or a sponsor incentive amount. The server computing device may visually represent incentivized goals in any of a wide variety of arrangements. For example, in some embodiments, the server computing device may apply different colors to represent the customer reserve amount and the sponsor incentive amount for each respective incentivized goal. In some embodiments, table arrangements may provide goal descriptions, customer reserve amounts, sponsor incentive amounts, combined customer reserve amount and sponsor incentive amount totals, and goal amounts in table columns. In some embodiments, progress bar arrangements may provide goal descriptions proximal to progress bars showing customer reserve amounts, sponsor incentive amounts, combined customer reserve amount and sponsor incentive amount totals, and goal amounts, along the progress bars. In some embodiments, pie chart arrangements may provide goal descriptions proximal to pie charts, wherein the customer reserve amounts and sponsor incentive amounts may be represented as slices of goal amounts. Incentivized goals may be visually represented according to these or any other arrangements as will be appreciated, and visual arrangements may be included in either or both of the customer level access to the customer account and/or the sponsor level access to the customer account.

In some embodiments, customer reserve amounts may include portions of the customer account reserved for each respective incentivized goal, and customer reserve amounts may be controllable by transfers between the customer reserve amounts and one or more other portions of the customer account. For example, customer level access to the customer account may include transfer controls to transfer funds into and out of each respective incentivized goal. In some embodiments, transfer controls may be configured to receive increase schedules for increases in customer reserve amounts for incentivized goals, e.g., reserving an additional amount each day, each week, or each month towards incentivized goals to which increase schedules may be applied.

In some embodiments, sponsor incentive amounts may include amounts committed by sponsors to each respective incentivized goal, and sponsor incentive amounts may be restricted to their respective incentivized goals and may be non-transferrable to other portions of the customer account. Furthermore, sponsor incentive amounts may comprise non-vested amounts, not belonging to customers until conditions are met, such as a sponsor vesting authorization. For example, sponsor incentive amounts may vest and become redeemable by the customer when the customer eventually uses corresponding customer reserve amounts to make purchases, investments, gifts, payments, or other applications of funds pursuant to the customer's incentivized goals. If the customer does not eventually use corresponding customer reserve amounts pursuant to the customer's incentivized goals, the customer's incentivized goals may eventually be canceled, either by the customer, the sponsor, or the server computing device, and the server computing device may be configured to correspondingly cancel or withdraw non-vested sponsor incentive amounts from the customer's account.

For example, in the case of the vehicle purchase incentivized goal described herein, a sponsor incentive amount may include an amount committed by the car dealership toward a vehicle purchase. The sponsor incentive amount may be restricted to the vehicle purchase and may be non-transferrable to other portions of the customer account. Furthermore, the sponsor incentive amount, while visible in the customer account, may comprise a non-vested amount not belonging to the customer until conditions are met, such as application of the sponsor incentive amount as a discount by the car dealership when the vehicle is purchased.

After the vehicle is purchased, or in the event that the customer does not eventually buy the vehicle in advance of a purchase deadline set for the incentivized goal, the incentivized goal may be canceled, either by the customer, the sponsor, or the financial institution, and the server computing device may be configured to correspondingly cancel or withdraw the sponsor incentive amount from the customer's account, and return the customer reserve amount to an unreserved balance of the customer account.

In some embodiments, instead of canceling or withdrawing sponsor incentive amounts after applying sponsor incentive amounts as discounts by sponsors, the server computing device may be configured to vest sponsor incentive amounts by releasing restriction thereof in response to sponsor vesting authorizations. Sponsor vesting authorizations may be granted by sponsors upon the customer meeting any conditions applicable to an incentivized goal, e.g., at conclusion of the vehicle purchase at the price specified in the vehicle purchase incentivized goal. In some embodiments, the server computing device may be configured to provide sponsor vesting authorization controls in sponsor access to incentivized goals. In some embodiments, the server computing device may receive sponsor vesting authorization from customers, e.g., vesting authorization codes provided by the car dealership or other sponsor to customers at conclusion of purchases. The server computing device may release restriction of sponsor incentive amounts in response to sponsor vesting authorizations, and the vested funds may thereby become transferrable among other portions of the customer account.

In some embodiments, the server computing device may be configured to vary sponsor incentive amounts for each respective incentivized goal according to sponsor incentive formulas for each respective incentivized goal. Sponsor incentive formulas may represent sponsor agreements to progressively adjust sponsor incentive amounts based on customer reserve amounts. The server computing device may be configured to receive different sponsor incentive formulas from different sponsors and/or for different incentivized goals sponsored by any single sponsor, and the server computing device may be configured to apply the different sponsor incentive formulas to corresponding incentivized goals in customer accounts.

Sponsor incentive formulas may take customer reserve amounts along with any other accompanying information described herein as inputs, and sponsor incentive formulas may output sponsor incentive amounts. For example, some sponsor incentive formulas may increase sponsor incentive amounts as a fixed percentage, e.g., 1%, 2%, 3% . . . of the customer reserve amount. Some sponsor incentive formulas may apply an accrual approach to adjust a sponsor incentive amounts, e.g., so that sponsor incentive amounts accrue from an initial value (e.g., zero or any other initial value) up to a full sponsor incentive amount. Other sponsor incentive formulas may be more complex. In general, sponsor incentive formulas may be customized by sponsors to establish desired customer incentives in order to produce desired customer behavioral effects.

For example, some sponsor incentive formulas may “front load” sponsor incentive amount increases by initially applying proportionally larger sponsor incentive amount increases, e.g., increases which are proportionally larger than a typical sponsor incentive amount increase as a proportion of customer reserve amount. Some sponsor incentive formulas may “back load” sponsor incentive increases by applying proportionally larger sponsor incentive amount increases as the customer reserve amount increases. Some sponsor incentive formulas may “front and back load” sponsor incentive increases by initially applying proportionally larger sponsor incentive amount increases, subsequently applying proportionally smaller sponsor incentive amount increases, and finally applying proportionally larger sponsor incentive amount increases as the combined customer reserve amount and sponsor incentive amount approaches the goal amount. Some sponsor incentive formulas may provide for “checkpoint incentives” by providing additional sponsor incentive amounts (e.g., sponsor incentive amounts which supplement baseline, fixed percentage sponsor incentive amount increases) when customer reserve amounts reach one or more checkpoint amounts. Some sponsor incentive formulas may incentivize multiple discrete increases in customer reserve amounts, e.g., by providing additional sponsor incentive amounts for each discrete increase in customer reserve amounts, or by providing additional sponsor incentive amounts for at least one discrete increase in customer reserve amount per time period such as per day, week, or month. Some sponsor incentive formulas may incentivize larger increases in customer reserve amounts, e.g., by providing additional sponsor incentive amounts for relatively large increases in customer reserve amounts, wherein relatively large increases may be larger than typical increases in customer reserve amounts. Some sponsor incentive formulas may incentivize speed of achieving an incentivized goal, e.g., by providing an additional sponsor incentive amount when the incentivized goal is reached, which additional sponsor incentive amount may be proportional to a speed or rate with which the incentivized goal was achieved. Some sponsor incentive formulas may account for customer history, e.g., by providing customers who have a history of achieving their incentivized goals with larger incentive amounts, or conversely, by providing customers who have a history of not achieving their incentivized goals with larger incentive amounts. Some sponsor incentive formulas may account for customer credit scores, e.g., by providing customers who have relatively better credit scores than other customers with larger incentive amounts, or conversely, by providing customers who have relatively worse credit scores than other customers with larger incentive amounts. The server computing device may be configured to vary sponsor incentive amounts according to these and/or any other sponsor incentive formulas.

In some embodiments, the server computing device may be configured to receive sponsor incentive formulas from sponsors, store received sponsor incentive formulas, and apply received sponsor incentive formulas dynamically based on changes in customer reserve amounts. Sponsor incentive amounts resulting from application of sponsor incentive formulas may be displayed, e.g., in a customer view of the customer account, in substantially real time. In some embodiments, the server computing device may be configured to confirm sponsor incentive amounts with sponsors, e.g., subsequent to calculating sponsor incentive amounts locally at the server computing device. In some embodiments, the server computing device may be configured to provide updated customer reserve amounts, sponsor incentive amounts, and/or other incentivized goal information to sponsors, either periodically or in real time as customer reserve amounts and corresponding sponsor incentive amounts are modified.

In some embodiments, the server computing device may be configured to provide updated customer reserve amounts, along with any accompanying information as may be input to sponsor incentive formulas, to a sponsor incentive amount calculation server, e.g. a server which may be managed by a sponsor. The sponsor incentive amount calculation server may be configured to execute sponsor incentive formulas for a particular sponsor, using updated customer reserve amounts and any accompanying information from the server computing device as inputs. The sponsor incentive amount calculation server may output updated sponsor incentive amounts, and may return the updated sponsor incentive amounts to the server computing device. The server computing device may receive, from the sponsor incentive amount calculation server, the updated sponsor incentive amounts, and the server computing device may apply the updated sponsor incentive amounts to corresponding incentivized goals in customer accounts. In some embodiments, communications between the server computing device and the sponsor incentive amount calculation server may be performed in real time and dynamically as customer reserve amounts are modified by the customer. In some embodiments, communications between the server computing device and the sponsor incentive amount calculation server may occur in other than real time, e.g., to allow processing time to calculate updated sponsor incentive amounts.

In some embodiments, the server computing device may be configured to enforce sponsor agreement rules, including penalties as may be included in such sponsor agreement rules or in sponsor incentive formulas, in addition to enabling incentives as described herein. For example, in some embodiments, sponsor incentive formulas may be configured to output reduced sponsor incentive amounts under certain conditions, e.g., when customer reserve amounts are reduced, or when customer reserve amounts are not increased according to an increase schedule. In such embodiments, the server computing device may effectively enforce penalties by applying sponsor incentive formulas.

In some embodiments, the server computing device may be configured to automatically enforce penalties included in sponsor agreement rules associated with incentivized goals. Penalties included in sponsor agreement rules may optionally be enforced separately from application of sponsor incentive formulas. For example, in some embodiments, the server computing device may be configured to automatically apply a predetermined customer penalty in the event that an agreed increase schedule for increases in a customer reserve amount is not followed by the customer. The server computing device may debit a customer account by an account penalty amount and/or reduce a sponsor incentive amount by an incentive penalty amount when a customer reserve amount for an incentivized goal is not increased according to an increase schedule. In some embodiments, the server computing device may be configured to automatically apply a predetermined sponsor penalty in the event that the sponsor (e.g., a merchant) fails to deliver a purchasable product or service at a cost specified by a goal amount. The server computing device may, e.g., credit a customer account by a merchant penalty amount in response to a failure by the merchant.

In some embodiments, the server computing device may be configured to reverse predetermined customer penalties, e.g., according to penalty reversal rules for incentivized goals as may be included in sponsor agreement rules. The server computing device may for example restore account penalty amounts and/or incentive penalty amounts to customer accounts when customer reserve amounts for incentivized goals are returned to agreed increase schedules. The server computing device may also apply incentives instead of or in addition to penalties, e.g., by increasing sponsor incentive amounts for incentivized goals by return incentive amounts, which amounts may be calculated by sponsor incentive formulas or otherwise, when customer reserve amounts for incentivized goals are returned to agreed increase schedules.

In some embodiments, the server computing device may be configured to enforce purchase deadlines e.g., according to purchase deadline rules for incentivized goals as may be included in sponsor agreement rules. For example, the server computing device may be configured to automatically cancel incentivized goals on or after purchase deadlines therefor. Customer reserve amounts may be moved back into the customer's unreserved balance. In some embodiments, the server computing device may be configured to notify the customer and/or the sponsor in advance of the purchase deadline, to promote agreement to extend the purchase deadline.

In some embodiments, the server computing device may be configured to provide order controls along with incentivized goals in customer level access to customer accounts. Example order controls may be configured to enable completion of incentivized goals. For example, in the case of purchase goals, example order controls may link to merchant webpages to purchase products or services to thereby attain incentivized goals. In some embodiments, order controls may be adapted to automatically provide information, such as a customer identity, customer account information, a product identification, an incentivized goal identification number, a customer reserve amount, and/or a sponsor incentive amount, to merchant webpages to facilitate purchases. In some embodiments, order controls may include selectable images of purchasable products or services.

In some embodiments, order controls may remain inactive until the combination or sum of customer reserve amount and sponsor incentive amount is equal to or greater than a goal amount for an incentivized goal. When order controls are inactive, the server computing device may, e.g., not link the order control to a merchant webpage and/or may not automatically provide information to merchant webpages to facilitate purchases. The server computing device may be configured to activate order controls when customer reserve amounts plus sponsor incentive amounts are equal to or greater than goal amounts, e.g., equal to or greater than the cost of a purchasable product or service. When order controls are active, the server computing device may, e.g., link the order control to a merchant webpage and/or may automatically provide information to merchant webpages to facilitate purchases.

In some embodiments, customer level access to stored financial account information in customer accounts may comprise multi-sponsor incentivized goals. Multi-sponsor incentivized goals may comprise a customer reserve amount along with multiple sponsor incentive amounts committed by multiple competing sponsors. For example, an incentivized goal may comprise a vehicle purchase. A customer reserve amount may represent customer savings toward the vehicle purchase, while the multiple sponsor incentive amounts may represent discounts committed by each of multiple competing car dealerships.

In some embodiments, multi-sponsor incentivized goals may optionally include different goal amounts and goal descriptions provided by each of the multiple sponsors. To enable multi-sponsor incentivized goals, the server computing device may be configured to allow customer selection of multiple incentivized goal offers in connection with a single incentivized goal. The server computing device may be configured to display multiple goal amounts, multiple goal descriptions, multiple order controls, and/or multiple sponsor incentive amounts along with a single incentivized goal and corresponding single customer reserve amount. In some embodiments, the server computing device may be configured to provide competing sponsor information, e.g., competing sponsor identities, competing sponsor goal amounts, competing sponsor goal descriptions, and/or competing sponsor incentive amounts, to competing sponsors for multi-sponsor incentivized goals.

In instances where the server computing device is a financial institution server, the customer level access to the stored financial account information may include full access to the customer account, e.g., access to overall account balance, account transactions, incentivized goals established for the customer account, account messages, tax documents, and/or any other account information, via a customer web interface. In some embodiments, customer level access to stored financial account information may include one or more incentivized goals, along with additional account information such as overall account balance, account transactions, account messages, tax documents, and/or any other account information, while sponsor level access to stored financial account information may include access, e.g., via a sponsor web interface, to the one or more incentivized goals and may exclude some or all of the additional account information, other than incentivized goals, such as overall account balance, account transactions, account messages, tax documents, and/or any other account information.

Example clearinghouse methods according to this disclosure may employ a clearinghouse server to enable multiple sponsor access to incentivized goals for multiple customer accounts at multiple financial institutions. Clearinghouse embodiments may efficiently scale to connect or associate a large number of sponsors with a large number of customers, thereby providing benefits of scale to both sponsors and customers.

Example clearinghouse methods may employ a clearinghouse server to mediate incentivized goal information between financial institutions, customers, and sponsors. The clearinghouse server may for example be configured to conduct automated communications with financial institution servers, and the clearinghouse server may be configured to communicate with customers and/or sponsors via a customer web interface and a sponsor web interface, respectively. In some embodiments, the clearinghouse server may be configured to conduct automated communications with sponsor servers.

In some embodiments, a clearinghouse server may be configured to mediate incentivized goal offers. The clearinghouse server may receive multiple incentivized goal offers from multiple sponsors and provide the multiple incentivized goal offers to multiple customers. The clearinghouse server may receive the multiple incentivized goal offers from sponsors via sponsor web interfaces and/or via automated communications with sponsor servers. The multiple customers may include customers with customer accounts at multiple financial institutions, and the clearinghouse server may be configured to provide the incentivized goal offers to customers directly, e.g., via customer web interfaces, or indirectly, via financial institution servers which may be adapted to provide the incentivized goal offers to their customers.

Each of the multiple incentivized goal offers may include, e.g., a goal description, a goal amount, and/or a sponsor incentive formula to progressively adjust a sponsor incentive amount includable in a customer account, based on a customer reserve amount includable in the customer account. The clearinghouse server may be configured to receive the multiple incentivized goal offers, e.g., as incentivized goal offer configuration files received from sponsor servers, or via incentivized goal offer configuration user interface (UI) provided by the clearinghouse server as part of the sponsor web interface.

In some embodiments, the multiple incentivized goal offers may comprise, e.g., purchase goal offers, wherein goal descriptions for the purchase goal offers may comprise descriptions of purchasable products or services, goal amounts for the purchase goal offers may comprise costs of the purchasable products or services, and sponsor incentive amounts established pursuant to sponsor incentive formulas for the purchase goal offers may comprise merchant commitments to discount the purchasable products or services when the purchasable products or services are purchased.

In some embodiments, a clearinghouse server may be configured to receive multiple incentivized goal offer selections from multiple customers and provide the multiple incentivized goal offer selections to multiple sponsors. The clearinghouse server may receive the multiple incentivized goal offer selections directly, e.g., via customer web interfaces, or indirectly, via financial institution servers which may be adapted to forward incentivized goal offer selections to the clearinghouse server. The clearinghouse server may provide the multiple incentivized goal offer selections to multiple sponsors via sponsor web interfaces and/or via automated communications with sponsor servers.

In some embodiments, a clearinghouse server may be configured to receive multiple customer reserve amounts for multiple incentivized goals established in customer accounts at multiple financial institutions pursuant to multiple incentivized goal offer selections, and provide the multiple customer reserve amounts to the multiple sponsors. The clearinghouse server may receive the customer reserve amounts directly, e.g., via a customer web interface, or indirectly, via financial institution servers which may be adapted to forward the customer reserve amounts to the clearinghouse server. The clearinghouse server may provide the multiple customer reserve amounts via sponsor web interfaces and/or via automated communications with sponsor servers.

In some embodiments, a clearinghouse server may be configured to receive multiple sponsor incentive amounts for multiple incentivized goals established in customer accounts and provide the multiple sponsor incentive amounts to multiple customers. The clearinghouse server may receive the sponsor incentive amounts via sponsor web interfaces and/or via automated communications with sponsor servers. The clearinghouse server may provide the multiple sponsor incentive amounts to multiple customers directly, e.g., via customer web interfaces, or indirectly, via financial institution servers which may be adapted to provide the sponsor incentive amounts to their customers. In some embodiments, a clearinghouse server may be configured to calculate sponsor incentive amounts locally or to receive sponsor incentive amounts as calculated a financial institution servers. The clearinghouse server may confirm locally calculated or received sponsor incentive amounts via sponsor web interfaces and/or via automated communications with sponsor servers, and the clearinghouse server may thereby effectively receive sponsor incentive amounts, or confirmations thereof, for multiple incentivized goals established in the customer accounts.

In some embodiments, a clearinghouse server may mediate any portion of communications between customers, financial institutions, and/or sponsors. Thus for example, in some embodiments, a clearinghouse server may mediate incentivized goal offers, while subsequent communications relating to incentivized goal offer selections, customer reserve amounts, and/or sponsor incentive amounts may occur directly between customers, financial institutions, and/or sponsors, without mediation by the clearinghouse server. In some embodiments, a clearinghouse server may mediate incentivized goal offers and incentivized goal offer selections, while subsequent communications relating to customer reserve amounts and/or sponsor incentive amounts may occur directly between customers, financial institutions, and/or sponsors, without mediation by the clearinghouse server. In some embodiments, a clearinghouse server may mediate incentivized goal offers, incentivized goal offer selections, and customer reserve amounts, while subsequent communications relating to sponsor incentive amounts may occur directly between customers, financial institutions, and/or sponsors, without mediation by the clearinghouse server. In some embodiments, a clearinghouse server may mediate incentivized goal offers, incentivized goal offer selections, customer reserve amounts, and sponsor incentive amounts.

Furthermore, operations described herein may be distributed among a clearinghouse server, financial institution servers, and/or sponsor servers according to a variety of different architectures. For example, in some embodiments, a clearinghouse server may mediate incentivized goal information, as described herein, without calculating sponsor incentive amounts locally. Instead, sponsor incentive amounts may be calculated at either financial institution servers or at sponsor servers. In some embodiments, a clearinghouse server may mediate incentivized goal information, as described herein, while also calculating sponsor incentive amounts. The clearinghouse server may provide calculated sponsor incentive amounts to financial institution servers, to sponsors via sponsor web interfaces and/or automated communications with sponsor servers, and optionally directly to customers via customer web interfaces. In some embodiments, a clearinghouse server may retrieve financial account information from financial institution servers, and the clearinghouse server may perform any of the operations described herein in connection with the disclosed server computing device.

In some embodiments, a clearinghouse server may acquire financial account information from financial institution servers, and the clearinghouse server may establish customer accounts, referred to herein as “clearinghouse accounts” at the clearinghouse server. Clearinghouse accounts may comprise acquired financial account information and any incentivized goals established for the clearinghouse accounts. The clearinghouse server may support direct customer level access, e.g., via customer web interfaces, to clearinghouse accounts. For example, the clearinghouse server may be configured to provide, based on customer security credentials, customer level access to stored financial account information from customer accounts at financial institutions, wherein each customer's customer level access may comprise multiple respective incentivized goals established for the customer account pursuant to the customer's incentivized goal offer selections in the clearinghouse account.

In some embodiments, a clearinghouse server may be configured to operate via financial institution servers to support establishment and maintenance of incentivized goals in customers' accounts at financial institutions, thereby allowing customers to establish and maintain their incentivized goals from their customer accounts at financial institutions, without necessarily also establishing clearinghouse accounts at the clearinghouse server.

In some embodiments, a sponsor web interface may comprise, e.g., sponsor user interfaces (UIs) generated at a clearinghouse server to provide sponsor account information. A clearinghouse server may be configured to provide, based on sponsor security credentials, sponsor level access to stored financial account information from multiple customers' customer accounts at multiple financial institutions, wherein the sponsor level access may comprise a subset of the multiple customers' incentivized goals, wherein the subset includes incentivized goals associated with the sponsor security credentials and excludes incentivized goals not associated with the sponsor security credentials.

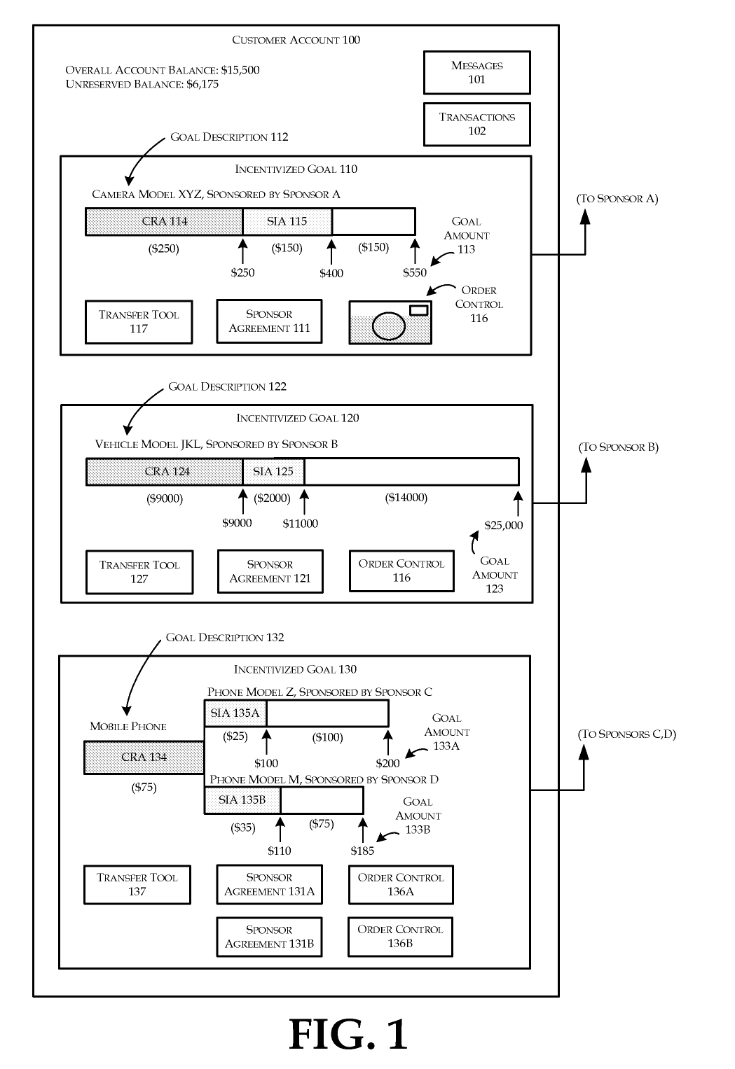

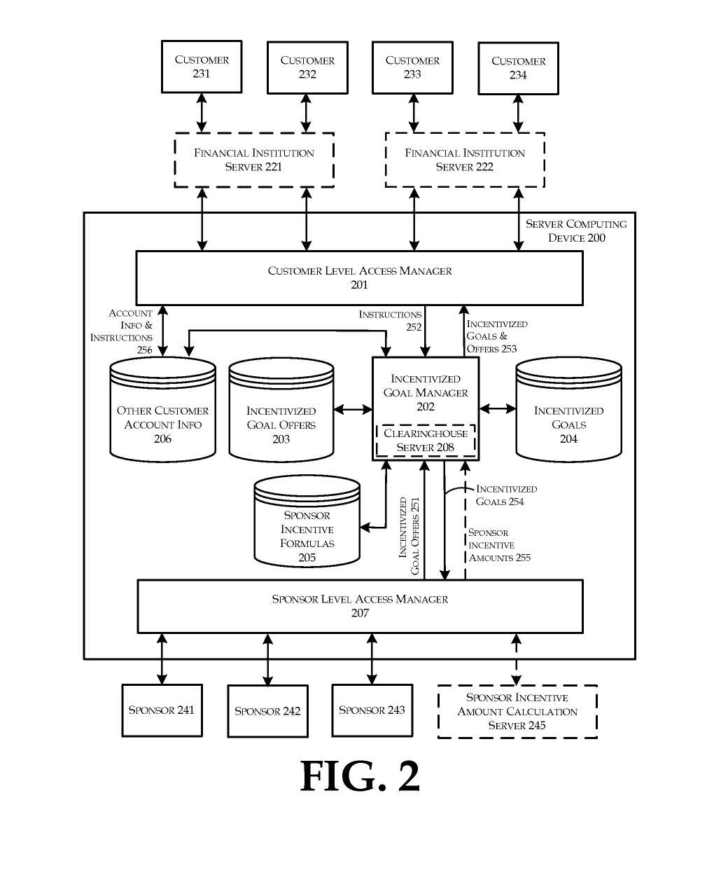

FIG. 1 is a diagram illustrating an example customer account including incentivized goals, arranged in accordance with at least some embodiments of the present disclosure. FIG. 1 includes a customer account 100, as may be viewed for example through customer level access to stored financial account information from customer account 100. Customer level access to customer account 100 may be provided by a server computing device such as illustrated in FIG. 2, based on customer security credentials. Customer account 100 includes an incentivized goal 110, an incentivized goal 120, and an incentivized goal 130. Customer account 100 may optionally also include a wide variety of other account information and/or account tools, such as, for example, an overall account balance, an unreserved balance, a messages access tool 101 adapted to load a display of account messages, and a transactions access tool 102 adapted to load a display of account transactions.

In some embodiments, incentivized goals 110, 120, and 130 may each be initially established in customer account 100 by a server computing device in response to customer acceptances of incentivized goal offers, not shown in FIG. 1. After incentivized goal 110 is established in customer account 100, incentivized goal 110 may include a goal description 112, a goal amount 113, a customer reserve amount (CRA) 114, a sponsor incentive amount (SIA) 115, a transfer tool 117, a sponsor agreement 111, and an order control 116. For incentivized goal 110, goal description 112 may comprise, for example, “Camera Model XYZ, Sponsored by Sponsor A”; goal amount 113 may comprise, for example, $550; customer reserve amount 114 may comprise, for example, $250, and sponsor incentive amount 115 may comprise, for example, $150. Thus incentivized goal 110 represents a customer goal to save $550 for the purchase of Camera Model XYZ, sponsored by Sponsor A. The customer has already saved $250 as customer reserve amount 114, and Sponsor A has committed $150 to the purchase of the camera, for a total of $250+$150=$400. The customer and Sponsor A may save or commit an additional $150 to reach the $550 of goal amount 113. In some embodiments, different textures or colors may be used to represent customer reserve amounts and sponsor incentive amounts, to allow for easy differentiation between customer reserve amounts and sponsor incentive amounts.

Incentivized goal 120 may include a goal description 122, a goal amount 123, a customer reserve amount (CRA) 124, a sponsor incentive amount (SIA) 125, a transfer tool 127, a sponsor agreement 121, and an order control 126. For incentivized goal 120, goal description 122 may comprise, for example, “Vehicle Model JKL, Sponsored by Sponsor B”; goal amount 123 may comprise, for example, $25,000; customer reserve amount 124 may comprise, for example, $9000, and sponsor incentive amount 125 may comprise, for example, $2000. Thus incentivized goal 120 represents a customer goal to save $25,000 for the purchase of Vehicle Model JKL, sponsored by Sponsor B. The customer has already saved $9000 as customer reserve amount 124, and Sponsor B has committed $2000 to the purchase of the vehicle, for a total of $9000+$2000=$11,000. The customer and Sponsor B may save or commit an additional $14,000 to reach the $25,000 of goal amount 123.

Incentivized goal 130 may include a multi-sponsor incentivized goal, comprising a goal description 132, a customer reserve amount (CRA) 134, multiple goal amounts including a goal amount 133A and a goal amount 133B, multiple sponsor incentive amounts (SIAs) including a sponsor incentive amount 135A and a sponsor incentive amount 135B, a transfer tool 137, multiple sponsor agreements including a sponsor agreement 131A and a sponsor agreement 131B, and multiple order controls including an order control 136A and an order control 136B. For incentivized goal 130, goal description 132 may comprise, for example, a generic description such as “Mobile Phone”. Multiple sponsors, e.g., Sponsor C and Sponsor D, may sponsor specific goals that match the generic description, such as “Phone Model Z, Sponsored by Sponsor C” and “Phone Model M, Sponsored by Sponsor D”. Goal amount 133A may comprise, for example, $200, and goal amount 133B may comprise, for example, $185. Sponsor incentive amount 135A may comprise, for example, $25, and sponsor incentive amount 135B may comprise, for example, $35. Thus incentivized goal 130 represents a customer goal to save for the purchase of a mobile phone, which purchase may be sponsored by any of multiple different sponsors, e.g., Sponsor C or Sponsor D. The customer has already saved $75 as customer reserve amount 134. Sponsor C has committed $25 to the purchase of the Phone Model Z, for a total of $75+$25=$100 for Phone Model Z. Sponsor D has committed $35 to the purchase of the Phone Model M, for a total of $75+$35=$110 for Phone Model M. The customer and Sponsor C may save or commit an additional $100 to reach the $200 of goal amount 133A, or the customer and Sponsor D may save or commit an additional $75 to reach the $185 of goal amount 133B.

Customer reserve amounts 114, 124, and 134 may be controllable by transfers between customer reserve amounts 114, 124, and 134 and one or more other portions of customer account 100. For example, transfer tools 117, 127, 137 may be configured to launch a transfer UI adapted to receive customer transfer instructions. Customers may transfer funds from the unreserved account balance into customer reserve amounts 114, 124, and 134, and vice versa. In some embodiments, customers may transfer funds from customer reserve amounts 124 and 134 for incentivized goals 120 and 130 into customer reserve amount 114 for incentivized goal 110, and vice versa. In some embodiments, a transfer UI may be adapted to receive increase schedules for increases in customer reserve amounts 114, 124, and 134. An increase schedule may include multiple transfers into a customer reserve amount, each of the multiple transfers to occur at a different future date. An increase schedule may, but need not, include transfers of a same amount and/or at regular intervals.

Sponsor incentive amounts 115, 125, 135A, and 135B may comprise amounts committed by sponsors, namely, Sponsor A, Sponsor B, Sponsor C, and Sponsor D, to respective incentivized goals 110, 120, 130. In some embodiments, sponsor incentive amounts 115, 125, 135A, and 135B may be restricted to respective incentivized goals 110, 120, and 130, and sponsor incentive amounts 115, 125, 135A, and 135B may not be transferrable to other portions of customer account 100. In other words, sponsor incentive amounts 115, 125, 135A, and 135B may not be transferrable to the unreserved balance or to other incentivized goals.

Sponsor incentive amounts 115, 125, 135A, and 135B may be varied according to sponsor incentive formulas for respective incentivized goals 110, 120, 130. Sponsor agreement 111, sponsor agreement 121, sponsor agreement 131A, and sponsor agreement 131B may be configured to display sponsor agreement rules for each of Sponsor A, Sponsor B, Sponsor C, and Sponsor D, respectively. The sponsor agreement rules may include the sponsor incentive formulas and/or other sponsor agreement rules and/or terms. A wide variety of different sponsor incentive formulas may be applied. In general, the sponsor incentive formulas may progressively adjust sponsor incentive amounts 115, 125, 135A, and 135B based on customer reserve amounts 114, 124, and 134, respectively, so that increases in customer reserve amounts 114, 124, and 134 produce increases in corresponding respective sponsor incentive amounts 115, 125, 135A, and 135B according to an applicable respective sponsor incentive formula. For example, in some embodiments, a sponsor incentive formula may increase a sponsor incentive amount for an incentivized goal as a fixed percentage of a customer reserve amount for the incentivized goal.

Example other sponsor agreement rules for sponsor agreements may include, for example, agreed increase schedules for customer incentive amounts and consequences for failure to meet the agreed increase schedules. Example consequences may include debiting customer account 100 by an account penalty amount when a customer reserve amount for an incentivized goal is not increased according to an increase schedule; reducing a sponsor incentive amount for an incentivized goal by an incentive penalty amount when a customer reserve amount for the incentivized goal is not increased according to the increase schedule; restoring the account penalty amount and/or the incentive penalty amount to customer account 100 when a customer reserve amount for an incentivized goal is returned to an increase schedule; and/or increasing a sponsor incentive amount for an incentivized goal by a return incentive amount when a customer reserve amount for an incentivized goal is returned to an increase schedule. Additional sponsor agreement rules may include, for example, merchant penalty amounts for failure by a merchant/sponsor to deliver a purchasable product or service at a cost specified by a goal amount.

In some embodiments, a server computing device configured to provide customer level access to customer account 100 such as illustrated in FIG. 1, may provide, based on sponsor security credentials, sponsor level access to the stored financial account information from customer account 100. The sponsor level access to the stored financial account information may comprise a subset of the multiple respective incentivized goals 110, 120, 130 included in the customer level access to the stored financial account information. The subset may include incentivized goals associated with sponsor security credentials, so that, for example, Sponsor A may be provided with information from incentivized goal 110, Sponsor B may be provided with information from incentivized goal 120, and Sponsor C and Sponsor D may be provided with information from incentivized goal 130. Meanwhile, the subset may exclude incentivized goals not associated with sponsor security credentials, so that, for example, Sponsor A may not be provided with information from incentivized goals 120 and 130, Sponsor B may not be provided with information from incentivized goals 110 and 130, and Sponsor C and Sponsor D may not be provided with information from incentivized goals 110 and 130. In some embodiments, the information provided to sponsors may also exclude other account information, such as overall account balance, unreserved balance, messages, and transactions.

Example incentivized goals 110, 120, and 130 may comprise purchase goals, wherein goal descriptions 112, 122, and 132 may comprise descriptions of purchasable products and goal amounts 113, 123, 133A and 133B may comprise costs of the purchasable products. Sponsors for incentivized goals 110, 120, and 130 may comprise merchants of the purchasable products, wherein the merchants sponsor incentivized goals 110, 120, and 130 by discounting the purchasable products in sponsor incentive amounts 115, 125, 135A and 135B when the purchasable products are purchased. It will be appreciated that purchasable services or other, non-purchase incentivized goals such as retirement savings may be substituted for purchasable products in some embodiments.

Incentivized goals 110, 120, and 130 may include order controls 116, 126, 136A, and 136B to order the purchasable products. For example, in some embodiments, order controls 116, 126, 136A, and 136B may each be configured to open an internet browser directed to a Uniform Resource Locator (URL) for a webpage from which a product described in a respective goal description 112, 122, or 132 may be purchased from Sponsor A, Sponsor B, Sponsor C, or Sponsor D, respectively. Order controls 116, 126, 136A, and 136B may optionally open customer-specific webpages which may be pre-populated by sponsors with applicable customer reserve amounts and sponsor incentive amounts. In some embodiments, order controls 116, 126, 136A, and 136B may be configured to electronically send incentivized goal data in the form of “cookies” or other data formats to sponsor web servers to enable population of sponsor web pages with customer reserve amounts and sponsor incentive amounts.

In some embodiments, order controls 116, 126, 136A, and 136B may remain inactive until a respective customer reserve amount plus a respective sponsor incentive amount is equal to or greater than a respective goal amount, e.g., a cost of a purchasable product or service. When an order control is inactive, selection of the inactive order control may have no effect, or may for example display a notice of insufficient funds reserved for the corresponding incentivized goal. Order controls 116, 126, 136A, and 136B may be activated when a respective customer reserve amount plus a respective sponsor incentive amount is equal to or greater than a respective goal amount. Activated order controls may be configured to enable order of purchase goals, as described herein.

In some embodiments, order controls may comprise an image, drawing, or other graphic representing the purchase goal, for example the illustrated drawing of a camera for order control 116. In some embodiments, order controls may graphically represent incentivized goal progress, for example, the camera drawing for order control 116 may comprise a portion in grayscale or color, which portion may correspond to incentivized goal progress.

FIG. 2 is a block diagram illustrating an example server computing device, arranged in accordance with at least some embodiments of the present disclosure. FIG. 2 includes a server computing device 200, and a variety of other devices and/or persons with which server computing device 200 may interact, including a financial institution server 221 and a financial institution server 222, a customer 231, a customer 232, a customer 233, and a customer 234, a sponsor 241, a sponsor 242, and a sponsor 243, and a sponsor incentive amount calculation server 245. FIG. 2 includes two financial institution servers, four customers, three sponsors, and one sponsor incentive amount calculation server as examples, and it will be appreciated that in some embodiments, server computing device 200 may interact with more or fewer financial institution servers, customers, sponsors, and/or sponsor incentive amount calculation servers.

Server computing device 200 includes a customer level access manager 201, an incentivized goal manager 202 comprising a clearinghouse server 208, incentivized goal offers 203, incentivized goals 204, sponsor incentive formulas 205, other customer account information 206, and a sponsor level access manager 207. It will be appreciated that the various components of server computing device 200 may be rearranged according to a wide variety of different configurations. For example, in some embodiments, incentivized goal manager 202 may comprise customer level access manager 201 and/or sponsor level access manager 207. In some embodiments, any of components of server computing device 200 may be provided at one or more separate servers which may be communicatively coupled with server computing device 200.

In some embodiments, customer level access manager 201 may be configured to provide to customers 231, 232, 233, and 234, based on customer security credentials, customer level access to stored financial account information from customer accounts. The customer level access may comprise, e.g., other customer account information 206 and incentivized goals 204 pertaining to respective customer accounts for respective customers 231, 232, 233, and 234. Server computing device 200 may provide customer level access via financial institution servers 221 and 222 and/or directly to customers 231, 232, 233, and 234 via customer web interfaces.

In some embodiments, sponsor level access manager 207 may be configured to provide to sponsors 241, 242, and 243, based on sponsor security credentials, sponsor level access to stored financial account information. The sponsor level access may comprise a respective subset of incentivized goals 204 associated with each respective sponsor 241, 242, and 243, and therefore associated with a respective sponsor's security credentials.

In some embodiments, incentivized goal manager 202 may be configured to receive incentivized goal offers 251 from sponsors 241, 242, and 243 and store incentivized goal offers 251 in incentivized goal offers 203. Incentivized goal manager 202 may store sponsor incentive formulas for incentivized goal offers 203 in sponsor incentive formulas 205.

In some embodiments, server computing device 200 may be configured to exchange account information and instructions 256 with customers 231, 232, 233, and 234. For example, server computing device 200 may provide account information such as account balances, transactions, messages, etc., to customers 231, 232, 233, and 234, and server computing device 200 may receive instructions such as funds transfers, messages, transaction search queries, etc., from customers 231, 232, 233, and 234.

In some embodiments, incentivized goal manager 202 may be configured to include incentivized goals and offers 253 along with account information from account information and instructions 256. Incentivized goals and offers 253 may include, inter alia, incentivized goal offers 203. Incentivized goal manager 202 may receive instructions 252 pertaining to incentivized goals and offers 253. Instructions 252 may include, e.g., customer incentivized goal offer selections. Incentivized goal manager 202 may be configured to establish incentivized goals 204 in customer accounts, responsive to received incentivized goal offer selections.

Subsequent to establishing incentivized goals 204, incentivized goal manager 202 may include incentivized goals 204 in incentivized goals and offers 253. Incentivized goal manager 202 may include, in incentivized goals and offers 253 provided to each respective customer 231, 232, 233, and 234, incentivized goals established for each respective customer 231, 232, 233, and 234. In addition to incentivized goal offer selections, instructions 252 may include, e.g., customer transfer instructions to increase or decrease customer reserve amounts for incentivized goals 204.

In some embodiments, incentivized goal manager 202 may be configured to adjust customer reserve amounts in incentivized goals 204 according to received instructions 252. Incentivized goal manager 202 may interact with other customer account information 206, e.g., to adjust general account balance and/or unreserved account balance inversely to customer reserve amounts.

Incentivized goal manager 202 may also be configured to vary sponsor incentive amounts for each respective incentivized goal in incentivized goals 204 according to sponsor incentive formulas 205 for each respective incentivized goal, wherein the sponsor incentive formulas 205 progressively adjust sponsor incentive amounts based on customer reserve amounts as described herein. In some embodiments, incentivized goal manager 202 may retrieve an applicable sponsor incentive formula, for a respective incentivized goal, from sponsor incentive formulas 205. Incentivized goal manager 202 may use the retrieved sponsor incentive formula, along with an adjusted customer reserve amount and/or any other sponsor incentive formula inputs, to calculate an adjusted sponsor incentive amount. Incentivized goal manager 202 may store the adjusted sponsor incentive amount with the corresponding incentivized goal in incentivized goals 204.

In some embodiments, incentivized goal manager 202 may be configured to send an adjusted customer reserve amount for a respective incentivized goal, and/or any other sponsor incentive formula inputs, to sponsor incentive amount calculation server 245. Sponsor incentive amount calculation server 245 is illustrated with a dashed line to suggest it is an optional element which need not be included in some embodiments. In an example application of sponsor incentive amount calculation server 245, incentivized goal manager 202 may include adjusted customer reserve amounts in incentivized goals 254 to thereby provide adjusted customer reserve amounts to sponsor incentive amount calculation server 245. Sponsor incentive amount calculation server 245 may calculate adjusted sponsor incentive amounts 255, and may return adjusted sponsor incentive amounts 255 to incentivized goal manager 202. Incentivized goal manager 202 may store received adjusted sponsor incentive amounts 255 with corresponding incentivized goals in incentivized goals 204.

In some embodiments, sponsors 241, 242, and 243 may include, e.g., human representatives of sponsor companies that access sponsor accounts via a sponsor web interface supported by server computing device 200. Server computing device 200 may be configured to generate sponsor UIs comprising incentivized goals 254 associated with each respective sponsor 241, 242, and 243. In some embodiments, server computing device 200 may be configured to generate sponsor UIs adapted to configure incentivized goal offers 251. In some embodiments, sponsors 241, 242, and 243 may include, e.g., sponsor servers adapted to automatically interact with server computing device 200. Server computing device 200 may be configured to automatically report incentivized goals 254 to respective sponsors 241, 242, and 243.

In some embodiments, incentivized goal manager 202 may be configured to support multi-sponsor incentivized goals. Incentivized goal manager 202 may include multi-sponsor incentivized goals among incentivized goals 204. Multi-sponsor incentivized goals may each be associated with a customer account and provided among customer level access to stored financial account information. Multi-sponsor incentivized goals may be associated with multiple sponsors, e.g., sponsors 241, 242, and 243, and multi-sponsor incentivized goals may be provided in sponsor level access to incentivized goals 204 for each of such multiple sponsors 241, 242, and 243. Incentivized goal manager 202 may optionally provide the multiple sponsor incentive amounts of a multi-sponsor incentivized goal to the multiple sponsors 241, 242, and 243, or incentivized goal manager 202 may otherwise provide each respective sponsor incentive amount of a multi-sponsor incentivized goal to a respective one of multiple sponsors 241, 242, and 243.

In some embodiments, incentivized goal manager 202 may be configured to implement various additional features disclosed herein. For example, incentivized goal manager 202 may be configured to automatically enforce sponsor agreement rules for incentivized goals 204. In this regard, incentivized goal manager 202 may be configured to automatically credit customer accounts by merchant penalty amounts in response to failures by merchants to deliver purchasable products or services at costs specified by goal amounts. Incentivized goal manager 202 may be configured to receive and implement increase schedules for increases in customer reserve amounts for incentivized goals 204. Incentivized goal manager 202 may be configured to debit customer accounts by account penalty amounts when customer reserve amounts for incentivized goals 204 are not increased according to increase schedules. Incentivized goal manager 202 may be configured to reduce sponsor incentive amounts for incentivized goals 204 by incentive penalty amounts when customer reserve amounts for incentivized goals 204 are not increased according to increase schedules. Incentivized goal manager 202 may be configured to restore account penalty amounts and/or incentive penalty amounts to customer accounts when customer reserve amounts for incentivized goals 204 are returned to increase schedules. Incentivized goal manager 202 may be configured to increase sponsor incentive amounts for incentivized goals 204 by return incentive amounts when customer reserve amounts for incentivized goals 204 are returned to increase schedules.

In some embodiments, incentivized goal manager 202 may be configured to include, in customer level access to incentivized goals 204, order controls for ordering purchasable products or services. Incentivized goal manager 202 may optionally activate order controls when customer reserve amounts plus sponsor incentive amounts are equal to or greater than costs of purchasable products or services. In some embodiments, incentivized goal manager 202 may be configured to include, in customer level access to incentivized goals 204, different colors to represent customer reserve amounts and sponsor incentive amounts for each respective incentivized goal.

In FIG. 2, financial institution servers 221 and 222 are illustrated using dashed lines to reflect that financial institution servers 221 and 222 need not necessarily be located between server computing device 200 and customers 231, 232, 233, and 234. For example, in some embodiments, server computing device 200 may comprise a financial institution server, and customers 231, 232, 233, and 234 may access server computing device 200 directly via customer web interfaces and not via other financial institution servers such as financial institution servers 221 and 222.

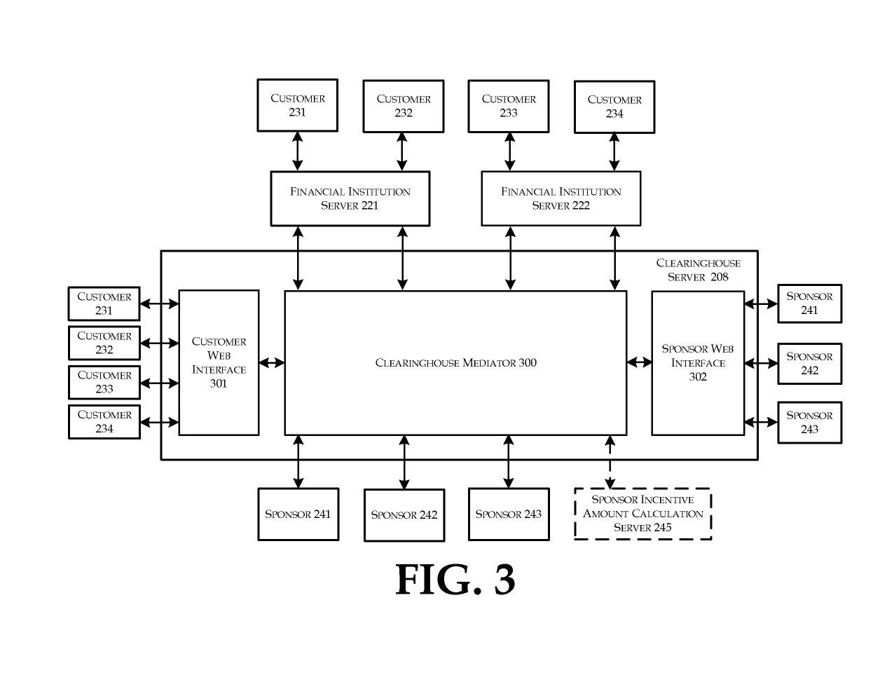

In some embodiments, server computing device 200 may comprise clearinghouse server 208, e.g., as a component of incentivized goal manager 202 or otherwise, to enable server computing device 200 to perform clearinghouse server functions as described further with reference to FIG. 3. For example, server computing device 200 may comprise clearinghouse server 208 in arrangements wherein server computing device 200 may be configured to support direct customer access to clearinghouse accounts at server computing device 200, while optionally also providing incentivized goal information to customers 231, 232, 233, and 234 via financial institution servers 221 and 222.

FIG. 3 is a block diagram illustrating an example clearinghouse server, arranged in accordance with at least some embodiments of the present disclosure. FIG. 3 includes clearinghouse server 208 as well as customers 231, 232, 233, and 234, financial institution servers 221 and 222, sponsors 241, 242, and 243, and sponsor incentive amount calculation server 245, illustrated in FIG. 2. In some embodiments, clearinghouse server 208 may be implemented independently from server computing device 200, as illustrated in FIG. 3. In such embodiments, functions of server computing device 200 may be implemented, e.g., within financial institution servers 221 and 222, and/or within sponsor servers at sponsors 241, 242, and 243.

Clearinghouse server 208 may include a clearinghouse mediator 300, a customer web interface 301, and a sponsor web interface 302. In some embodiments, clearinghouse mediator 300 may be configured to automatically interact with financial institution servers 221 and 222, sponsors 241, 242, and 243, and/or sponsor incentive amount calculation server 245. In some embodiments, clearinghouse mediator 300 may be configured to interact with customers 231, 232, 233, and 234 via customer web interface 301. In some embodiments, clearinghouse mediator 300 may be configured to interact with sponsors 241, 242, and 243 via sponsor web interface 302.

In some embodiments, clearinghouse mediator 300 may be configured to enable multiple sponsor access, e.g., by multiple sponsors 241, 242, and 243, to incentivized goal information for multiple customer accounts, e.g., accounts for each of customers 231, 232, 233, and 234. Clearinghouse mediator 300 may be configured to receive multiple incentivized goal offers from multiple sponsors 241, 242, and 243 and provide the multiple incentivized goal offers to multiple customers 231, 232, 233, and 234, wherein the multiple customers 231, 232, 233, and 234 may include customers with customer accounts at multiple financial institutions, namely, financial institutions associated with each of financial institution servers 221 and 222. Clearinghouse mediator 300 may provide the multiple incentivized goal offers to multiple customers 231, 232, 233, and 234 via customer web interface 301 and/or via financial institution servers 221 and 222.

Incentivized goal offers received at clearinghouse mediator 300 may each comprise, inter alia, a goal description, a goal amount, and/or a sponsor incentive formula to progressively adjust a sponsor incentive amount includable in a customer account, based on a customer reserve amount includable in the customer account. In some embodiments, incentivized goal offers may comprise further information, such as additional sponsor agreement rules as described herein. In some embodiments, incentivized goal offers may include, e.g., an Internet Protocol (IP) address, security credentials, and/or other information to enable clearinghouse mediator 300 and/or financial institution servers 221 and 222 to communicate with sponsor incentive amount calculation server 245.

In some embodiments, clearinghouse mediator 300 may be configured to receive multiple incentivized goal offer selections from multiple customers 231, 232, 233, and 234. Incentivized goal offer selections may be generated, e.g., through customer selections, via customer web interface 301 and/or via financial institution servers 221 and 222, of incentivized goal offer selection controls provided in incentivized goal offers. The incentivized goal offer selections may be forwarded to clearinghouse mediator 300.

In some embodiments, clearinghouse mediator 300 may be configured to provide the multiple incentivized goal offer selections to multiple sponsors 241, 242, and 243. Clearinghouse mediator 300 may provide received incentivized goal offer selections to sponsor(s) among multiple sponsors 241, 242, and 243 whose incentivized goal offers were selected by customers 231, 232, 233, and 234. In some embodiments, clearinghouse mediator 300 may provide incentivized goal offer selections to sponsors 241, 242, and 243 without substantial delay and/or dynamically upon customer adjustment thereof, e.g., in the form of messages or reports sent to any of sponsors 241, 242, and 243. The messages or reports may include, e.g., numbers of incentivized goal offer selections, customer identifiers associated with incentivized goal offer selections, or other incentivized goal offer selection information.

In some embodiments, clearinghouse mediator 300 may be configured to receive multiple customer reserve amounts for multiple incentivized goals established in customer accounts at multiple financial institutions pursuant to multiple incentivized goal offer selections. Customers 231 and 232 may have customer accounts at a financial institution associated with financial institution server 221, and customers 233 and 234 may have customer accounts at a financial institution associated with financial institution server 222. Clearinghouse mediator 300 may receive customer reserve amounts from customers 231, 232, 233, and 234 having accounts at the multiple financial institutions, via customer web interface 301 and/or via financial institution servers 221 and 222.

In some embodiments, clearinghouse mediator 300 may be configured to provide multiple received customer reserve amounts to multiple sponsors 241, 242, and 243. Clearinghouse mediator 300 may provide received customer reserve amounts and/or customer reserve amounts calculated locally within server computing device 200 to sponsor(s) among multiple sponsors 241, 242, and 243 whose incentivized goals are affected by customer reserve amount adjustments. In some embodiments, clearinghouse mediator 300 may provide customer reserve amounts to sponsors 241, 242, and 243 without substantial delay and/or dynamically upon customer adjustment thereof, e.g., in the form of messages or reports sent to any of sponsors 241, 242, and 243, the messages or reports including adjusted customer reserve amounts. In some embodiments, clearinghouse mediator 300 may provide customer reserve amounts to sponsors 241, 242, and 243 in the context of other incentivized goal information sent to sponsors 241, 242, and 243, wherein other incentivized goal information may for example summarize incentivized goals established in customer accounts and associated with a sponsor among sponsors 241, 242, and 243.

In some embodiments, clearinghouse mediator 300 may be configured to receive multiple sponsor incentive amounts for multiple incentivized goals established in customer accounts. For example, in some embodiments, server computing device 200, illustrated in FIG. 2, may initially calculate sponsor incentive amounts for incentivized goals 204, using sponsor incentive formulas 205, customer reserve amounts in incentivized goals 204, and/or any other inputs as may be used by sponsor incentive formulas 205. Clearinghouse server 208 may confirm sponsor incentive amounts established pursuant to sponsor incentive formulas 205, e.g., by sending incentivized goals 254, comprising subsets of incentivized goals 204, to sponsors 242, 242, and 243, and receiving sponsor confirmations of incentivized goals 254, in order to effectively receive the multiple sponsor incentive amounts for multiple incentivized goals 254 established in customer accounts.

In some embodiments, clearinghouse server 208 may forego calculating sponsor incentive amounts locally, and clearinghouse mediator 300 may instead send incentivized goals to sponsor incentive amount calculation servers, such as sponsor incentive amount calculation server 245. Sponsor incentive amount calculation server 245 may calculate sponsor incentive amounts and return sponsor incentive amounts to clearinghouse mediator 300. Clearinghouse mediator 300 may thereby receive multiple sponsor incentive amounts for multiple incentivized goals established in customer accounts.

In some embodiments, clearinghouse mediator 300 may be configured to provide multiple sponsor incentive amounts to multiple customers 231, 232, 233, and 234. For example, clearinghouse mediator 300 may forward to customer web interface 301 and/or to financial institution servers 221 and 222, sponsor incentive amounts and/or sponsor incentive amount confirmations received from sponsors 242, 242, and 243 and/or sponsor incentive amount calculation servers such as sponsor incentive amount calculation server 245.

In embodiments wherein clearinghouse server 208 is configured to operate via financial institution servers 221 and 222, clearinghouse mediator 300 may be configured to interact with multiple financial institution servers 221 and 222 to provide multiple incentivized goal offers to multiple customers 231, 232, 233, and 234 via customer accounts at multiple financial institutions. For example, incentivized goal manager 202 may provide incentivized goal offers for storage at financial institution servers 221 and 222, so that financial institution servers 221 and 222 may include incentivized goal offers in customer account UIs.

Furthermore, in embodiments wherein clearinghouse server 208 is configured to operate via financial institution servers 221 and 222, clearinghouse mediator 300 may be configured to receive multiple incentivized goal offer selections from multiple customers 231, 232, 233, and 234 via customer accounts at multiple financial institutions. For example, financial institution servers 221 and 222 may be configured to forward incentivized goal offer selections to clearinghouse server 208, and clearinghouse mediator 300 may thereby receive the forwarded incentivized goal offer selections. Similarly, financial institution servers 221 and 222 may be configured to forward customer reserve amount transfer information to clearinghouse server 208, and clearinghouse mediator 300 may thereby receive multiple customer reserve amounts for multiple incentivized goals established in customer accounts via customer accounts at multiple financial institutions.

In some embodiments, clearinghouse mediator 300 may be configured to interact with multiple financial institution servers 221 and 222 to provide multiple sponsor incentive amounts to multiple customers 231, 232, 233, and 234 via customer accounts at multiple financial institutions. For example, clearinghouse mediator 300 may provide incentivized goals for storage at financial institution servers 221 and 222, so that financial institution servers 221 and 222 may include incentivized goals in customer account UIs.

In embodiments wherein clearinghouse server 208 is configured to support direct customer access to clearinghouse accounts, e.g., via customer web interface 301, customer level access manager 201, illustrated in FIG. 2, may be configured to provide, based on customer security credentials, customer level access to stored financial account information from customer accounts at financial institutions. For example, financial institutions associated with financial institution servers 221 and 222 may configure financial institution servers 221 and 222 to cooperate with server computing device 200 to send customer account information for use in clearinghouse accounts. Customer level access manager 201 may then support direct access to clearinghouse accounts by customers 231, 232, 233, and 234. The clearinghouse accounts may comprise incentivized goals established for customer accounts pursuant to customer 231, 232, 233, and/or 234 incentivized goal offer selections.

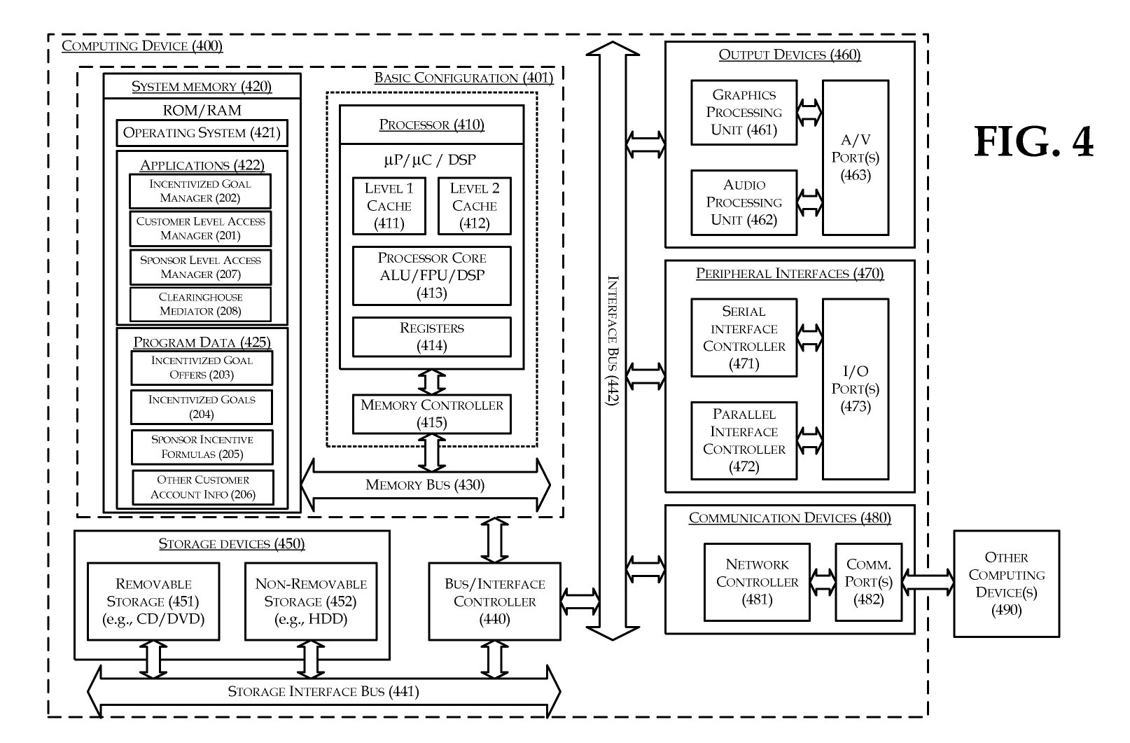

FIG. 4 is a block diagram of a computing device 400 as one example of a server computing device and clearinghouse server, arranged in accordance with at least some embodiments of the present disclosure. In a very basic configuration 401, computing device 400 may include one or more processors 410 and system memory 420. A memory bus 430 may be used for communicating between the processor 410 and the system memory 420.

Depending on the desired configuration, processor 410 may be of any type including but not limited to a microprocessor (μP), a microcontroller (μC), a digital signal processor (DSP), or any combination thereof. Processor 410 may include one or more levels of caching, such as a level one cache 411 and a level two cache 412, a processor core 413, and registers 414. The processor core 413 may include an arithmetic logic unit (ALU), a floating point unit (FPU), a digital signal processing core (DSP Core), or any combination thereof. A memory controller 415 may also be used with the processor 410, or in some implementations the memory controller 415 may be an internal part of the processor 410.

Depending on the desired configuration, the system memory 420 may be of any type including but not limited to volatile memory (such as RAM), non-volatile memory (such as ROM, flash memory, etc.), or any combination thereof. System memory 420 typically includes an operating system 421, one or more applications 422, and program data 425. In some embodiments, operating system 421 may comprise a virtual machine that is managed by a Virtual Machine Manager (VMM). Applications 422 may include, for example, incentivized goal manager module(s) 202, customer level access manager module(s) 201, sponsor level access manager module(s) 207, and/or clearinghouse mediator module(s). Program data 425 may include, e.g., incentivized goal offers 203, incentivized goals 204, sponsor incentive formulas 205 and/or other customer account information 206 that may be used by applications 422.

Computing device 400 may have additional features or functionality, and additional interfaces to facilitate communications between the basic configuration 401 and any required devices and interfaces. For example, a bus/interface controller 440 may be used to facilitate communications between the basic configuration 401 and one or more data storage devices 450 via a storage interface bus 441. The data storage devices 450 may be removable storage devices 451, non-removable storage devices 452, or a combination thereof. Examples of removable storage and non-removable storage devices include magnetic disk devices such as flexible disk drives and hard-disk drives (HDD), optical disc drives such as compact disc (CD) drives or digital versatile disc (DVD) drives, solid state drives (SSD), and tape drives, to name a few. Example computer storage media may include volatile and nonvolatile, removable and non-removable media implemented in any method or technology for storage of information, such as computer readable instructions, data structures, program modules, or other data.

Level 1 cache 411, level 2 cache 412, system memory 420, removable storage 451, and non-removable storage devices 452 are all examples of computer storage media. Computer storage media includes, but is not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other medium that may be used to store the desired information and that may be accessed by computing device 400. Any such computer storage media may be part of device 400.

Computing device 400 may also include an interface bus 442 for facilitating communication from various interface devices (e.g., output interfaces, peripheral interfaces, and communication interfaces) to the basic configuration 401 via the bus/interface controller 440. Example output devices 460 include a graphics processing unit 461 and an audio processing unit 462, which may be configured to communicate to various external devices such as a display or speakers via one or more A/V ports 463. Example peripheral interfaces 470 may include a serial interface controller 471 or a parallel interface controller 472, which may be configured to communicate through either wired or wireless connections with external devices such as input devices (e.g., keyboard, mouse, pen, voice input device, touch input device, etc.) or other peripheral devices (e.g., printer, scanner, etc.) via one or more I/O ports 473. Other conventional I/O devices may be connected as well such as a mouse, keyboard, and so forth. An example communications device 480 includes a network controller 481, which may be arranged to facilitate communications with one or more other computing devices 490 over a network communication via one or more communication ports 482.

The computer storage media may be one example of a communication media. Communication media may typically be embodied by computer readable instructions, data structures, program modules, or other data in a modulated data signal, such as a carrier wave or other transport mechanism, and include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), infrared (IR), and other wireless media.

Computing device 400 may be implemented as a server computing device as described in connection with FIG. 2, or as a clearinghouse server as described in connection with FIG. 3. As such, computing device 400 may be implemented as a financial institution server or as a clearinghouse server, as described herein.

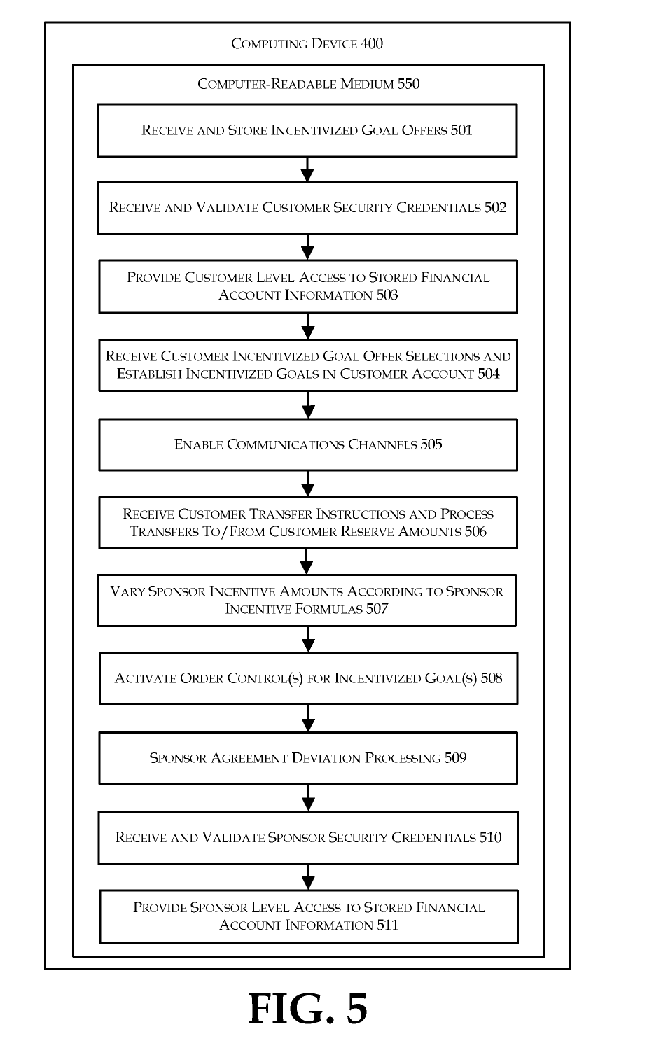

FIG. 5 is a flow diagram illustrating an example method configured to enable sponsor access to incentivized customer account goals, arranged in accordance with at least some embodiments of the present disclosure. The example flow diagram may include one or more operations/modules as illustrated by blocks 501-511, which represent operations as may be performed in a method, functional modules in a computing device 400, and/or instructions as may be recorded on a computer readable medium 550.

In FIG. 5, blocks 501-511 are illustrated as including blocks being performed sequentially, e.g., with block 501 first and block 511 last. It will be appreciated however that these blocks may be re-arranged as convenient to suit particular embodiments and that these blocks or portions thereof may be performed concurrently in some embodiments. It will also be appreciated that in some examples various blocks may be eliminated, divided into additional blocks, and/or combined with other blocks.

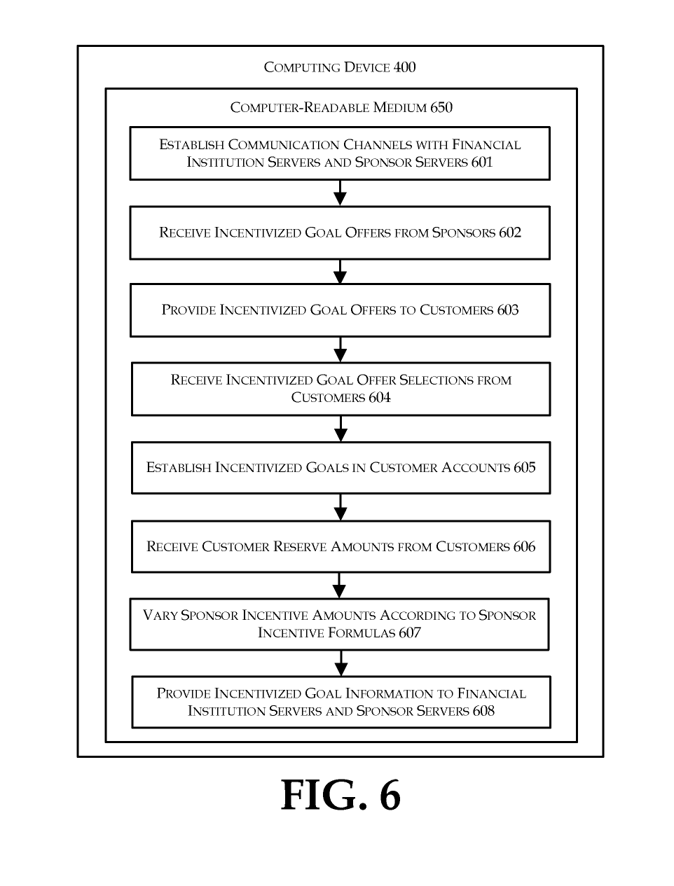

FIG. 5 illustrates an example method by which computing device 400 may generally receive and distribute incentivized goal offers to customers, establish incentivized goals in customer accounts pursuant to customers' incentivized goal offer selections, allow customer transfers to and from customer reserve amounts, vary sponsor incentive amounts according to sponsor incentive formulas, and/or provide for both customer level access and sponsor level access to incentivized goal information. In some embodiments, the operations illustrated in FIG. 5 may be implemented by server computing devices, such as server computing device 200 as illustrated in FIG. 2. In some embodiments, the operations illustrated in FIG. 5 may be performed in combination with clearinghouse operations, such as described with reference to FIG. 6.

At a “Receive and Store Incentivized Goal Offers” block 501, computing device 400 may receive incentivized goal offers from sponsors, and computing device 400 may store received incentivized goal offers for presentation to customers. Incentivized goal offers may each include, e.g., a goal description, a goal amount, an initial customer reserve amount, an initial sponsor incentive amount, and/or a sponsor incentive formula. Incentivized goal offers may optionally also include offer advertisements, such as images or text for use in presenting incentivized goal offers to customers. Block 501 may be followed by block 502.

At a “Receive and Validate Customer Security Credentials” block 502, computing device 400 may receive customer security credentials, such as a customer username and password, from a customer computer, optionally via a financial institution server. Computing device 400 may validate the received customer security credentials, for example, by comparing received customer security credentials to customer security credentials stored at computing device 400. Block 502 may be followed by block 503.

At a “Provide Customer Level Access to Stored Financial Account Information” block 503, if the customer security credentials received at block 502 are validated, computing device 400 may provide, based on the received customer security credentials, customer level access to stored financial account information from a customer account. The customer level access may include a display of customer account information such as account balance and transaction history, along with customer tools to manage the customer account. The customer level access may also comprise any incentivized goals established for the customer account, and any incentivized goal offers received at block 501. In some embodiments, computing device 400 may select a set of incentivized goal offers to present to a customer based on customer profile information, such as customer transaction history, customer age, customer gender, and/or customer account balance. Block 503 may be followed by block 504.

At a “Receive Customer Incentivized Goal Offer Selections and Establish Incentivized Goals in Customer Account” block 504, computing device 400 may receive any customer incentivized goal offer selections, and computing device 400 may establish incentivized goals in the customer account pursuant to the incentivized goal offer selections. Computing device 400 may establish an incentivized goal in the customer account for example by creating an incentivized goal object in the customer account, wherein the incentivized goal object includes properties specified in a selected incentivized goal offer, such as a goal description, a goal amount, an initial customer reserve amount, an initial sponsor incentive amount, and/or a sponsor incentive formula, as specified in the selected incentivized goal offer. Block 504 may be followed by block 505.

At an “Enable Communications Channels” block 505, computing device 400 may enable communications channels for communications between customers and sponsors. For example, in some embodiments, computing device 400 may present a UI including selectable communications preferences, to allow the customer to select allowable communications channels relating to each of the customer's incentivized goals. Selectable communications preferences may include, e.g., a preference regarding direct sponsor to customer communications, a preference regarding communications from a sponsor via a financial institution, a preference regarding providing customer information such as name, address, email, and/or telephone number to a sponsor, a preference regarding receiving other incentivized goal offers from a sponsor, a preference regarding allowing sponsors of a multi-sponsor incentivized goal to see other sponsors' sponsor incentive amounts relating to the multi-sponsor incentivized goal, and a preference regarding receiving add-on offers or additional incentives relating to an incentivized goal. Computing device 400 may provide sponsors with communications preference information and/or establish communications channels for sponsor-customer communications according to customer communications preferences. Block 505 may be followed by block 506.

At a “Receive Customer Transfer Instructions and Process Transfers To/From Customer Reserve Amounts” block 506, computing device 400 may receive customer transfer instructions for an incentivized goal in the customer account. Computing device 400 may process the transfer instructions by transferring an amount of funds, as specified in the transfer instructions, between the customer reserve amount for the incentivized goal and one or more other portions of the customer account, such as an unreserved balance portion or another incentivized goal in the customer account. In some embodiments, the transfer instructions may include an increase schedule for increases in the customer reserve amount for an incentivized goal, and computing device 400 may schedule future transfers based on the increase schedule. Block 506 may be followed by block 507.

At a “Vary Sponsor Incentive Amounts According to Sponsor Incentive Formulas” block 507, in some embodiments, computing device 400 may recalculate sponsor incentive amounts for incentivized goals for which transfer instructions are processed at block 506. For example, computing device 400 may retrieve a sponsor incentive formula for a respective incentivized goal, and computing device 400 may input a new customer reserve amount, as modified per block 506, to the sponsor incentive formula to recalculate the sponsor incentive amount. In some embodiments, computing device 400 may supply other information as additional inputs to sponsor incentive formulas as described herein. Sponsor incentive formulas may increase sponsor incentive amounts as fixed percentages of customer reserve amounts for incentivized goals, or sponsor incentive formulas may otherwise progressively adjust sponsor incentive amounts based on customer reserve amounts according to the example approaches described herein or as may be otherwise developed with the benefit of this disclosure.

In some embodiments, computing device 400 may send a new customer reserve amount, as modified per block 506, to a sponsor incentive amount calculation server, such as may be identified with incentivized goal offer information received and stored at block 501, and computing device 400 may receive a recalculated sponsor incentive amount from the sponsor incentive amount calculation server.

Computing device 400 may store recalculated sponsor incentive amounts with corresponding incentivized goals. In some embodiments, computing device 400 may adjust sponsor incentive amounts in substantially real time and computing device 400 may display recalculated sponsor incentive amounts to customers in substantially real time upon customer adjustment of customer reserve amounts. Block 507 may be followed by block 508.

At an “Activate Order Control(s) for Incentivized Goal(s)” block 508, in embodiments wherein order controls are activated upon reaching incentivized goals, computing device 400 may activate an order control included in an incentivized goal when a customer reserve amount plus a sponsor incentive amount for the incentivized goal is equal to or greater than the cost of a purchasable product or service defined by the incentivized goal. Block 508 may be followed by block 509.

At a “Sponsor Agreement Deviation Processing” block 509, computing device 400 may apply any sponsor agreement rules, such as may be identified among incentivized goal offer information received and stored at block 501. For example, sponsor agreement rules may specify a merchant penalty amount to be credited to the customer account in response to a failure by a merchant sponsor to deliver a purchasable product or service, as identified in an incentivized goal, at a cost specified by a goal amount in the incentivized goal. Computing device 400 may receive a confirmation of the merchant failure, and computing device 400 may responsively credit the customer account by the merchant penalty amount.

In another example, sponsor agreement rules may specify an increase schedule for increases in a customer reserve amount for an incentivized goal, and rules to be applied in the event of deviations from the increase schedule. Computing device 400 may for example debit the customer account by an account penalty amount, as specified in sponsor agreement rules, when the customer reserve amount for the incentivized goal is not increased according to the increase schedule. Computing device 400 may for example reduce the sponsor incentive amount for the incentivized goal by an incentive penalty amount, as specified in sponsor agreement rules, when the customer reserve amount for the incentivized goal is not increased according to the increase schedule. Computing device 400 may for example restore the account penalty amount or the incentive penalty amount to the customer account, as specified in sponsor agreement rules, when the customer reserve amount for the incentivized goal is returned to the increase schedule. Computing device 400 may for example increase the sponsor incentive amount for the incentivized goal by a return incentive amount, as specified in sponsor agreement rules, when the customer reserve amount for the incentivized goal is returned to the increase schedule. Numerous other sponsor agreement rules may be applied by computing device 400 as will be appreciated with the benefit of this disclosure. Computing device 400 may be arranged to receive custom sponsor agreement rules packages from sponsors, wherein each custom sponsor agreement rules package is associated with an incentivized goal offer, and computing device 400 may enforce the various different custom sponsor agreement rules in the context of each respective incentivized goal. Block 509 may be followed by block 510.

At a “Receive and Validate Sponsor Security Credentials” block 510, computing device 400 may receive sponsor security credentials, such as a sponsor username and password, from a sponsor computer. Computing device 400 may validate the received sponsor security credentials, for example, by comparing received sponsor security credentials to sponsor security credentials stored at computing device 400. Block 510 may be followed by block 511.

At a “Provide Sponsor Level Access to Stored Financial Account Information” block 511, if the sponsor security credentials received at block 510 are validated, computing device 400 may provide, based on the received sponsor security credentials, sponsor level access to stored financial account information from customer accounts. The sponsor level access may include a report or display of incentivized goals associated with the received sponsor security credentials, namely, the incentivized goals sponsored by a particular sponsor. Such incentivized goals may include, e.g., incentivized goals from multiple different customer accounts, while not necessarily including all incentivized goals from any one customer account. Thus for example, in a scenario in which sponsors A, B, C, and D each sponsor incentivized goals for customers C1, C2, C3, and C4, sponsor level access for sponsor A may include incentivized goals C1(A), C2(A), C3(A), and C43(A), while sponsor level access for sponsor A may exclude incentivized goals C1(B), C2(B), C3(B), and C43(B), as well as the incentivized goals associated with sponsors C and D. In other words, sponsor level access may include a subset of incentivized goals included in customer level access to stored financial account information, wherein the subset may include incentivized goals associated with the sponsor security credentials and may exclude incentivized goals not associated with the sponsor security credentials.

FIG. 6 is a flow diagram illustrating an example clearinghouse method configured to enable multiple sponsor access to incentivized customer account goals for multiple customer accounts, arranged in accordance with at least some embodiments of the present disclosure. The example flow diagram may include one or more operations/modules as illustrated by blocks 601-608, which represent operations as may be performed in a method, functional modules in a computing device 400, and/or instructions as may be recorded on a computer readable medium 650.

In FIG. 6, blocks 601-608 are illustrated as including blocks being performed sequentially, e.g., with block 601 first and block 608 last. It will be appreciated however that these blocks may be re-arranged as convenient to suit particular embodiments and that these blocks or portions thereof may be performed concurrently in some embodiments. It will also be appreciated that in some examples various blocks may be eliminated, divided into additional blocks, and/or combined with other blocks.

FIG. 6 illustrates an example method by which computing device 400 may generally provide a clearinghouse to distribute incentivized goal offers from multiple sponsors to multiple customers, wherein the multiple customers may have customer accounts at multiple financial institutions. In some embodiments, clearinghouse may furthermore enable multiple sponsor access to incentivized goals established pursuant to the incentivized goal offers.

At an “Establish Communication Channels with Financial Institution Servers and Sponsor Servers” block 601, computing device 400 may establish communication channels with financial institution servers and sponsor servers. In some embodiments, computing device 400 may implement interfaces for automated communications with financial institution servers and/or sponsor servers. Computing device 400 may be supplied with security credentials for financial institution servers to allow secure communications between computing device 400 and financial institution servers, and vice versa. Computing device 400 may be supplied with security credentials for sponsor servers to allow secure communications between computing device 400 and sponsor servers, and vice versa. In some embodiments, computing device 400 may implement an interface for automated communications with financial institution servers, and computing device 400 may provide a sponsor web interface for sponsor level access, e.g., to a sponsor's incentivized goal offers and information from the sponsor's incentivized goals established in customer accounts. In some embodiments, computing device 400 may additionally provide a customer web interface for customer level access, e.g., to a customer's incentivized goal offers and the customer's incentivized goals. Block 601 may be followed by block 602.

At a “Receive Incentivized Goal Offers from Sponsors” block 602, computing device 400 may receive, via either a sponsor web interface or interface for automated communications with sponsor servers, multiple incentivized goal offers from multiple sponsors. Different sponsors may provide different incentivized goal offers to computing device 400 at different times, and computing device 400 may store received incentivized goal offers for distribution to customers. Each of the received incentivized goal offers may comprise different incentivized goal offer information as defined by the different sponsors. For example, each of the incentivized goal offers may comprise a goal description, a goal amount, and a sponsor incentive formula. Incentivized goal offers may optionally also include sponsor agreement rules to be applied in connection with incentivized goals, as described herein. Block 602 may be followed by block 603.

At a “Provide Incentivized Goal Offers to Customers” block 603, computing device 400 may provide the multiple incentivized goal offers received at block 602 to multiple customers, including customers with customer accounts at multiple financial institutions. The multiple financial institutions may comprise those financial institutions with which communication channels are established at block 601. In some embodiments, computing device 400 may interact with financial institution servers to provide the multiple incentivized goal offers to the multiple customers via the customer's accounts at the multiple financial institutions. Computing device 400 may send the multiple incentivized goal offers to the financial institution servers, and the financial institution servers may provide the multiple incentivized goal offers to their respective customers as appropriate. In some embodiments, computing device 400 may provide the multiple incentivized goal offers to the multiple customers directly, e.g., through a customer web interface supported at computing device 400. Block 603 may be followed by block 604.

At a “Receive Incentivized Goal Offer Selections from Customers” block 604, computing device 400 may receive multiple incentivized goal offer selections from multiple customers. In some embodiments, computing device 400 may interact with financial institution servers to receive the multiple incentivized goal offer selections from the multiple customers indirectly, via customer accounts at the multiple financial institutions. For example, financial institution servers may forward customers' incentivized goal offer selections to computing device 400 in substantially real time as incentivized goal offers are selected and established in customer accounts. Forwarded incentivized goal offer selections may comprise, e.g., identifications of incentivized goal offers which were selected, selection dates and times, identifications of customers making the incentivized goal offer selections, customer communication preferences, initial customer reserve amounts, initial sponsor incentive amounts, identifications of other sponsors, other goal amounts, and/or other goal descriptions for multi-sponsor incentivized goals, and/or any other information pertaining to incentivized goal offer selections and corresponding incentivized goals established in customer accounts. In some embodiments, computing device 400 may receive incentivized goal offer selections from the multiple customers directly via a customer web interface provided by computing device 400.

In some embodiments, block 603 and/or block 604 may be followed by block 608, omitting blocks 605-607. At block 608, computing device 400 may report incentivized goal offer selections received at block 604 to sponsor servers, and sponsor servers may thereafter exchange customer reserve amounts and sponsor incentive amounts for incentivized goals with financial institution servers, either via computing device 400 or otherwise. In other embodiments, computing device 400 may include blocks 605-607 in order to support establishing and managing incentivized goals in customer accounts. In such embodiments, block 604 may be followed by block 605.

At an “Establish Incentivized Goals in Customer Accounts” block 605, computing device 400 may establish incentivized goals in customer accounts, pursuant to incentivized goal offer selections received at block 604. In some embodiments, computing device 400 may establish incentivized goals in customer clearinghouse accounts. Computing device 400 may create and store an incentivized goal object for each incentivized goal offer selection received at block 604 in a clearinghouse account for a customer which made the incentivized goal offer selection. In some embodiments, computing device 400 may establish incentivized goals in customer accounts at financial institutions. Computing device 400 may create an incentivized goal object for each incentivized goal offer selection received at block 604, and computing device 400 may send incentivized goal objects to financial institution servers for use in customer accounts. Block 605 may be followed by block 606.

At a “Receive Customer Reserve Amounts from Customers” block 606, computing device 400 may receive multiple customer reserve amounts for multiple incentivized goals established, e.g., at block 605, in customer accounts such as customer clearinghouse accounts and/or customer accounts at multiple financial institutions. In some embodiments, computing device 400 may interact with multiple financial institution servers to receive the multiple customer reserve amounts for multiple incentivized goals established in customer accounts indirectly via customer accounts at multiple financial institutions. For example, financial institution servers may forward updated customer reserve amounts to computing device 400 in substantially real time as customer reserve amounts are adjusted pursuant to customer transfer instructions. Forwarded customer reserve amount information may comprise, e.g., identifications of customer accounts, incentivized goals, and updated customer reserve amounts. In some embodiments, computing device 400 may receive customer reserve amounts from the multiple customers directly via a customer web interface provided by computing device 400. Block 606 may be followed by block 607.

At a “Vary Sponsor Incentive Amounts According to Sponsor Incentive Formulas” block 607, computing device 400 may vary sponsor incentive amounts for the incentivized goals for which customer reserve amounts are received at block 606. Computing device 400 may generally perform operations as described herein in connection with FIG. 4, block 407. Computing device 400 may calculate sponsor incentive amounts locally, using locally stored sponsor incentive formulas, or computing device 400 may provide multiple customer reserve amounts to multiple sponsors, e.g., to sponsor incentive amount calculation servers, which may calculate and return sponsor incentive amounts to computing device 400. In some embodiments, computing device 400 may store recalculated sponsor incentive amounts with corresponding incentivized goals, optionally accessible directly via customer clearinghouse accounts. In some embodiments, computing device 400 may send recalculated sponsor incentive amounts to financial institution servers in order to provide the recalculated sponsor incentive amounts to multiple customers indirectly via customer accounts at multiple financial institutions. Block 607 may be followed by block 608.

At a “Provide Incentivized Goal Information to Financial Institution Servers and Sponsor Servers” block 608, computing device 400 may provide incentivized goal information to financial institution servers and/or sponsor servers, as desired to implement any of the various architectures which may be implemented in view of this disclosure. For example, in some embodiments, computing device 400 may provide multiple incentivized goal offer selections to multiple sponsors, e.g. by reporting incentivized goal offer selections, received at block 604, to sponsor servers in substantially real time. In some embodiments, computing device 400 may provide multiple customer reserve amounts to multiple sponsors, e.g., by reporting customer reserve amounts, received at block 606, to sponsor servers in substantially real time. In some embodiments, computing device 400 may provide multiple sponsor incentive amounts, received or otherwise calculated at block 607, to multiple customers via financial institution servers in substantially real time. Embodiments may alternatively or additionally provide information to sponsors and/or customers via sponsor and customer web interfaces, as described herein.

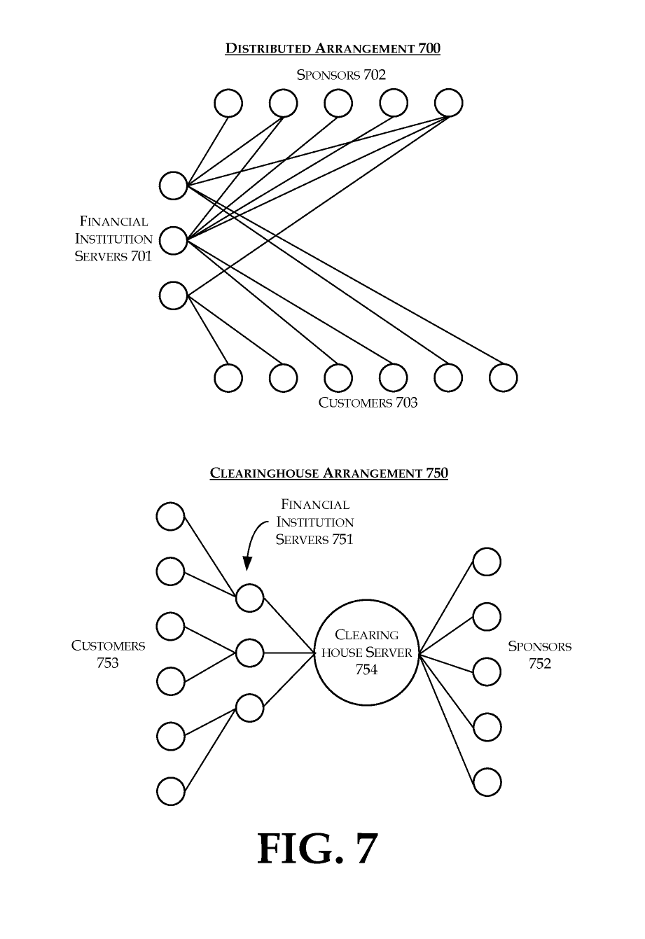

FIG. 7 is a schematic diagram illustrating an example distributed arrangement 700 and an example clearinghouse arrangement 750, arranged in accordance with at least some embodiments of the present disclosure. In both distributed arrangement 700 and clearinghouse arrangement 750, financial institution servers 701 and 751 each interact with their respective customers 703 and 753.

In distributed arrangement 700, financial institution servers 701 may each be arranged as server computing device 200 such as illustrated in FIG. 2 while omitting clearinghouse server 208. Financial institution servers 701 may each separately interact with different subsets of sponsors 702. As a result, sponsors 702 may engage in multiple communications with multiple different financial institution servers 701, which may result in inefficiencies in providing incentivized goal offers to customers 703.

In contrast, in clearinghouse arrangement 750, clearinghouse server 754 may be arranged as clearinghouse server 208 such as illustrated in FIG. 3, or optionally as server computing device 200 comprising clearinghouse server 208 as illustrated in FIG. 2. Financial institution servers 751 may each be arranged, e.g., as server computing devices 200 such as illustrated in FIG. 2. Financial institution servers 751 may each separately interact with clearinghouse server 754, and sponsors 752 may each separately interact with clearinghouse server 754. As a result, sponsors 752 may experience increased efficiency in their communications with clearinghouse server 754, and financial institution servers 751 may gain efficient access to more sponsors than in the distributed arrangement, which may result in efficiencies in providing incentivized goal offers to customers 753.

There is little distinction left between hardware and software implementations of aspects of systems; the use of hardware or software is generally (but not always, in that in certain contexts the choice between hardware and software may become significant) a design choice representing cost vs. efficiency tradeoffs. There are various vehicles by which processes and/or systems and/or other technologies described herein may be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disc (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems. The herein described subject matter sometimes illustrates different components contained within, or connected with, different other components. It is to be understood that such depicted architectures are merely examples and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermediate components. Likewise, any two components so associated may also be viewed as being “operably connected”, or “operably coupled”, to each other to achieve the desired functionality, and any two components capable of being so associated may also be viewed as being “operably couplable”, to each other to achieve the desired functionality. Specific examples of operably couplable include but are not limited to physically connectable and/or physically interacting components and/or wirelessly inter-actable and/or wirelessly interacting components and/or logically interacting and/or logically inter-actable components.

With respect to the use of substantially any plural and/or singular terms herein, those having skill in the art may translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While certain example techniques have been described and shown herein using various methods, devices and systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to the particular examples disclosed, but that such claimed subject matter also may include all implementations falling within the scope of the appended claims, and equivalents thereof.

1. A method to enable sponsor access to incentivized customer account goals, comprising:
providing, by a server computing device, based on customer security credentials, customer level access to stored financial account information from a customer account;
wherein the customer level access to the stored financial account information comprises multiple respective incentivized goals, each respective incentivized goal comprising:
a goal description;
a goal amount;
a customer reserve amount comprising a portion of the customer account reserved for the respective incentivized goal, wherein the customer reserve amount is controllable by transfers between the customer reserve amount and one or more other portions of the customer account; and
a sponsor incentive amount comprising an amount committed by a sponsor to the respective incentivized goal, wherein the sponsor incentive amount is restricted to the respective incentivized goal and is not transferrable to other portions of the customer account;
varying, by the server computing device, sponsor incentive amounts for each respective incentivized goal according to sponsor incentive formulas for each respective incentivized goal, wherein the sponsor incentive formulas progressively adjust sponsor incentive amounts based on customer reserve amounts; and
providing, by the server computing device, based on sponsor security credentials, sponsor level access to the stored financial account information, wherein the sponsor level access to the stored financial account information comprises a subset of the multiple respective incentivized goals included in the customer level access to the stored financial account information, wherein the subset includes incentivized goals associated with the sponsor security credentials and excludes incentivized goals not associated with the sponsor security credentials.

2. The method of claim 1, wherein the method further comprises incentivized goal clearinghouse operations, including:
receiving, by the server computing device, multiple incentivized goal offers from multiple sponsors and providing, by the server computing device, the multiple incentivized goal offers to multiple customers, wherein the multiple customers include customers with customer accounts at multiple financial institutions;
receiving, by the server computing device, multiple incentivized goal offer selections from the multiple customers and providing, by the server computing device, the multiple incentivized goal offer selections to the multiple sponsors;
receiving, by the server computing device, multiple customer reserve amounts for multiple incentivized goals established in the customer accounts at the multiple financial institutions pursuant to the multiple incentivized goal offer selections, and providing, by the server computing device, the multiple customer reserve amounts to the multiple sponsors; and
receiving, by the server computing device, multiple sponsor incentive amounts for the multiple incentivized goals established in the customer accounts, and providing, by the server computing device, the multiple sponsor incentive amounts to the multiple customers.

3. The method of claim 1, wherein one or more of the multiple respective incentivized goals comprises a purchase goal, and wherein:
the goal description for the purchase goal comprises a description of a purchasable product or service;
the goal amount for the purchase goal comprises a cost of the purchasable product or service; and
a sponsor for the purchase goal comprises a merchant of the purchasable product or service, wherein the merchant sponsors the purchase goal by discounting the purchasable product or service in the sponsor incentive amount when the purchasable product or service is purchased.

4. The method of claim 3, further comprising crediting, by the server computing device, the customer account by a merchant penalty amount in response to a failure by the merchant to deliver the purchasable product or service at the cost specified by the goal amount.

5. The method of claim 3, wherein the customer level access to the financial account information comprises an order control for ordering the purchasable product or service, and wherein the server computing device method further comprises activating, by the server computing device, the order control when the customer reserve amount plus the sponsor incentive amount is equal to or greater than the cost of the purchasable product or service.

6. The method of claim 1, further comprising receiving, by the server computing device, an increase schedule for increases in the customer reserve amount for an incentivized goal among the multiple respective incentivized goals.

7. The method of claim 6, further comprising one or more of:
debiting, by the server computing device, the customer account by an account penalty amount when the customer reserve amount for the incentivized goal is not increased according to the increase schedule;
reducing, by the server computing device, the sponsor incentive amount for the incentivized goal by an incentive penalty amount when the customer reserve amount for the incentivized goal is not increased according to the increase schedule;
restoring, by the server computing device, one or more of the account penalty amount or the incentive penalty amount to the customer account when the customer reserve amount for the incentivized goal is returned to the increase schedule; or
increasing, by the server computing device, the sponsor incentive amount for the incentivized goal by a return incentive amount when the customer reserve amount for the incentivized goal is returned to the increase schedule.

8. The method of claim 1, wherein a sponsor incentive formula for an incentivized goal among the multiple respective incentivized goals increases the sponsor incentive amount for the incentivized goal as a fixed percentage of the customer reserve amount for the incentivized goal.

9. The method of claim 1, wherein the customer level access to the stored financial account information comprises different colors to represent the customer reserve amount and the sponsor incentive amount for each respective incentivized goal.

10. The method of claim 1, wherein the customer level access to the stored financial account information comprises at least one multi-sponsor incentivized goal among the multiple respective incentivized goals, wherein the at least one multi-sponsor incentivized goal comprises multiple sponsor incentive amounts committed by multiple competing sponsors.

11. A non-transitory computer readable storage medium having computer executable instructions executable by a processor, the instructions that, when executed by the processor, cause the processor to:
provide, based on customer security credentials, customer level access to stored financial account information from a customer account;
wherein the customer level access to the stored financial account information comprises multiple respective incentivized goals, each respective incentivized goal comprising:
a goal description;
a goal amount;
a customer reserve amount comprising a portion of the customer account reserved for the respective incentivized goal, wherein the customer reserve amount is controllable by transfers between the customer reserve amount and one or more other portions of the customer account; and
a sponsor incentive amount comprising an amount committed by a sponsor to the respective incentivized goal, wherein the sponsor incentive amount is restricted to the respective incentivized goal and is not transferrable to other portions of the customer account;
vary sponsor incentive amounts for each respective incentivized goal according to sponsor incentive formulas for each respective incentivized goal, wherein the sponsor incentive formulas progressively adjust sponsor incentive amounts based on customer reserve amounts; and
provide sponsor level access to the stored financial account information based on sponsor security credentials, wherein the sponsor level access to the stored financial account information comprises a subset of the multiple respective incentivized goals included in the customer level access to the stored financial account information, wherein the subset includes incentivized goals associated with the sponsor security credentials and excludes incentivized goals not associated with the sponsor security credentials.

12-20. (canceled)

21. A server computing device to enable sponsor access to incentivized customer account goals, comprising:
a processor;
a memory; and
a customer level access manager stored in the memory and executable by the processor, wherein the customer level access manager is configured to:
provide, based on customer security credentials, customer level access to stored financial account information from a customer account;
wherein the customer level access to the stored financial account information comprises multiple respective incentivized goals, each respective incentivized goal comprising:
a goal description;
a goal amount;
a customer reserve amount comprising a portion of the customer account reserved for the respective incentivized goal, wherein the customer reserve amount is controllable by transfers between the customer reserve amount and one or more other portions of the customer account; and
a sponsor incentive amount comprising an amount committed by a sponsor to the respective incentivized goal, wherein the sponsor incentive amount is restricted to the respective incentivized goal and is not transferrable to other portions of the customer account;
an incentivized goal manager stored in the memory and executable by the processor, wherein the incentivized goal manager is configured to vary sponsor incentive amounts for each respective incentivized goal according to sponsor incentive formulas for each respective incentivized goal, wherein the sponsor incentive formulas progressively adjust sponsor incentive amounts based on customer reserve amounts; and
a sponsor level access manager stored in the memory and executable by the processor, wherein the sponsor level access manager is configured to provide, based on sponsor security credentials, sponsor level access to the stored financial account information, wherein the sponsor level access to the stored financial account information comprises a subset of the multiple respective incentivized goals included in the customer level access to the financial account information, wherein the subset includes incentivized goals associated with the sponsor security credentials and excludes incentivized goals not associated with the sponsor security credentials.

22. The server computing device of claim 21, wherein the incentivized goal manager is configured to:
receive multiple incentivized goal offers from multiple sponsors and provide the multiple incentivized goal offers to multiple customers, wherein the multiple customers include customers with customer accounts at multiple financial institutions;
receive multiple incentivized goal offer selections from the multiple customers and provide the multiple incentivized goal offer selections to the multiple sponsors;
receive multiple customer reserve amounts for multiple incentivized goals in multiple customer accounts at the multiple financial institutions, and provide the multiple customer reserve amounts to the multiple sponsors; and
receive multiple sponsor incentive amounts for the multiple incentivized goals in multiple customer accounts at the multiple financial institutions and provide the multiple sponsor incentive amounts to the multiple customers.

23. The server computing device of claim 21, wherein one or more of the multiple respective incentivized goals comprises a purchase goal, and wherein:
the goal description for the purchase goal comprises a description of a purchasable product or service;
the goal amount for the purchase goal comprises a cost of the purchasable product or service; and
a sponsor for the purchase goal comprises a merchant of the purchasable product or service, wherein the merchant sponsors the purchase goal by discounting the purchasable product or service in the sponsor incentive amount when the purchasable product or service is purchased.

24. The server computing device of claim 23, wherein the incentivized goal manager is configured to credit the customer account by a merchant penalty amount in response to a failure by the merchant to deliver the purchasable product or service at the cost specified by the goal amount.

25. The server computing device of claim 23, wherein the customer level access to the financial account information comprises an order control for ordering the purchasable product or service, and wherein the incentivized goal manager is configured to activate the order control when the customer reserve amount plus the sponsor incentive amount is equal to or greater than the cost of the purchasable product or service.

26. The server computing device of claim 21, wherein the incentivized goal manager is configured to receive an increase schedule for increases in the customer reserve amount for an incentivized goal among the multiple respective incentivized goals.

27. The server computing device of claim 26, wherein the incentivized goal manager is configured to one or more of:
debit the customer account by an account penalty amount when the customer reserve amount for the incentivized goal is not increased according to the increase schedule;
reduce the sponsor incentive amount for the incentivized goal by an incentive penalty amount when the customer reserve amount for the incentivized goal is not increased according to the increase schedule;
restore one or more of the account penalty amount or the incentive penalty amount to the customer account when the customer reserve amount for the incentivized goal is returned to the increase schedule; or
increase the sponsor incentive amount for the incentivized goal by a return incentive amount when the customer reserve amount for the incentivized goal is returned to the increase schedule.

28. The server computing device of claim 21, wherein a sponsor incentive formula for an incentivized goal among the multiple respective incentivized goals increases the sponsor incentive amount for the incentivized goal as a fixed percentage of the customer reserve amount for the incentivized goal.

29. The server computing device of claim 21, wherein the customer level access to the stored financial account information comprises different colors to represent the customer reserve amount and the sponsor incentive amount for each respective incentivized goal.

30. The server computing device of claim 21, wherein the customer level access to the stored financial account information comprises at least one multi-sponsor incentivized goal among the multiple respective incentivized goals, wherein the at least one multi-sponsor incentivized goal comprises multiple sponsor incentive amounts committed by multiple competing sponsors.

31-45. (canceled)
